(19) United States
(12) Patent Application Publication
(10) Pub. No.: US 2015/0286799 A1
(43) Pub. Date: Oct. 8, 2015

(54) MANAGEMENT OF MEDICATION DOSE ORDERS

(71) Applicant: Baxter Corporation Englewood, Englewood, CO (US)

(72) Inventors: Bhavesh Padmani, Port Orange, FL (US); Matthew Crooks, Daytona Beach, FL (US); Maher Yassine, Ormond Beach, FL (US); Bapu Hirave, Daytona Beach, FL (US); Robert Kelly Hammond, Port Orange, FL (US); Jayson Lee Bender, Deland, FL (US); Matthew A. Valentine, Ormond Beach, FL (US); Dennis A. Tribble, Ormond Beach, FL (US)

(21) Appl. No.: 14/678,648

(22) Filed: Apr. 3, 2015

Related U.S. Application Data
(60) Provisional application No. 61/975,519, filed on Apr. 4, 2014.

(51) Int. Cl. G06F 19/00

(52) U.S. Cl. CPC G06F 19/3456

(57) ABSTRACT

A system for preparing and managing patient-specific dose orders includes an order processing server configured to receive the patient-specific dose orders, define a queue of dose orders and distribute the dose orders to at least one dose preparation station. The dose preparation station is in bi-directional communication with the order processing server and has an interface for providing an operator with a protocol associated with each received drug order and specifying a set of steps to fill the drug order. Steps to fill the drug order are captured at the station and a display, positionable independent of the station outputs the dose order queue and metrics concerning activity at the dose preparation station. Systems for preparing patient-specific doses and a method for telepharmacy in which data captured while following the protocol are provided to a remote site for review and approval by a pharmacist.

### CROSS-REFERENCE TO RELATED APPLICATION

This application claims priority from U.S. Provisional Application No. 61/975,519 filed on Apr. 4, 2014, entitled “MANAGEMENT OF MEDICATION DOSE ORDERS,” the contents of which are incorporated by reference herein as if set forth in full.

### TECHNICAL FIELD

The present invention relates to the management of medication dose orders and medication dose preparation, and more particularly to some or all of the systems and steps taken in connection with access by a remote terminal to perform management functions related to medication dose order records at a local server and operations related to a rule-based approach to medication order management.

### BACKGROUND

In many medical facilities, medication orders are transmitted to a pharmacy from various locations throughout the hospital and by various means of communication. The process by which these medication orders are managed involves many discrete steps. Orders must be entered, transmitted and received by the pharmacy, validated, and filled according to manufacturer's specifications or established institutional guidelines. The filling process involves the selection and, where required, preparation of drug products for administration to patients in compliance with the validated order. Once filled, the resulting drug products (i.e., doses) must be delivered to the patient that requires them. One environment, by way of example, in which such transmissions and processes occur, is a hospital.

There are points in the process that are susceptible to miscommunication or loss of information. This can be problematic in terms of logging and auditing the processing and preparation of medications, which is often mandated by insurance and regulatory requirements.

The pharmacy operationally receives these medication dose orders in the form of printed labels, typically generated by a hospital pharmacy computer system, one for each medication dose order to be dispensed. In many cases, a separate label is printed for each dose to be dispensed. Pharmacists and technicians use these labels as work documents to identify the medications to make and properly prepare and issue the desired medication. The labels are then used as address labels to ensure that the medications are routed to the correct patient for use. These labels lack detailed preparation steps, causing the technician to rely on his or her memory of the preparation procedures and guidelines, seek input from a co-operator, or find a manufacturer's package insert or a written institutional guideline.

One hazard of this method is that the label represents the only record of the work needing to be performed with the result that, if the label is lost or damaged, the work may not be performed (that is, the medication dose order may not be fulfilled) and the omission does not become known until a caregiver complains because they cannot locate the medication, or because a patient experiences an adverse event because of omitted medication. Furthermore, modification (e.g., changes to or discontinuations) of previously printed orders are provided in the form of another label, which is required to be matched to a prior printed label to facilitate the modification. Thus, an operator may be required to match a subsequent order label to a prior order label to modify and/or discontinue a dose order. If such matching does not occur prior to preparation of the initial order, a dose order may be prepared in an incorrect manner or duplicate orders may be prepared, thus potentially wasting operator time and drug resources.

U.S. Pat. No. 7,096,212 for “Serial Data Capture and Processing” and U.S. Patent Application No. 2003/0097368 for “Data Transmission Capture in Support of Medication Preparation” describe technology for automating the preparation of medication dose orders in response to the printing of such labels, the entire disclosures of which are hereby incorporated by reference, as though set forth in their respective entireties. However, these systems do not manage the distribution of medication dose orders to the various pharmacy workstations at which they are to be prepared, nor do they track the distribution of the completed dose orders to the patient for whom they are intended or provide detailed management of subsequent receipt of orders to modify prior orders. Furthermore, such systems may be limited to application within a local environment such that remote access capability may be limited.

While many medications can be prepared by automated systems containing “built in” knowledge of correct preparation procedures, there are still large numbers of medication dose orders that require manual preparation, or institutions whose size precludes the incorporation of automation technology. The information and knowledge regarding how to prepare the medication is typically transferred verbally from one person to another. Thus, if a clinician receives an order for which he is unaware of the correct procedure for fulfillment, the clinician would have to request assistance, and thereby acknowledge a lack of training for that particular task. However, seeking training can be a source of embarrassment or be perceived as an undesired delay, either scenario providing a potential basis for the clinician to potentially use an improper procedure for the preparation of a particular medication, significantly increasing the possibility of a serious medication error due to flawed preparation procedures. Repeated conduct in this regard can result in “self trained” experience in a manner which is inconsistent with published procedures for handling that medication. Typically, the correct procedures are defined and written in a manual or other documentation. However, there is currently no efficient way to present the relevant excerpt of the manual to the clinician in relation to the particular medication order to be processed.

Furthermore, after a doctor or nurse enters a medication order, determining the status of the order requires manual intervention. The progress of the order cannot easily be determined. The order must be located, determined if it has been filled, then possibly located somewhere throughout a facility, such as a hospital, which can be complicated further as the medication dose is being transferred to the patient or as patients are moved from one location to another (e.g., from the patient's room to physical therapy or a lab).

Workload management systems for hospitals and sterile products preparation are unsophisticated and incapable of properly managing the process, causing conflicts between the level of staffing provided and the level of work to be performed.

Centralized preparation of medication dose orders within a hospital or pharmacy creates a further set of logistical problems. A large number of medication dose received within the same general time frame can quickly outpace the production capabilities of the hospital. Further, hospital pharmacies generally have no way of separating medication dose orders that are needed immediately from those dose orders that are less urgent.

For example, IV rooms currently operate via manual distribution of labels and this type of system can lead to a number of problems, including the following problems. Currently, a pharmacy that “kits” work for transmission to the IV room obtains one or more labels from a label printer, mentally determines what products and supplies are needed to prepare the requested doses, assembles those items, places the items and the labels in a bin and passes that bin into the IV room. There is no verification of correct drugs. In addition, doses are not tracked; doses become acknowledged as “lost” when a nurse indicates that an expected dose was not received at the patient care area. Some doses are very difficult to track because they cannot be prepared as soon as the label is received. Manual tracking methods often result in those doses being overlooked. There are currently no tracking metrics can definitively state what amount of work is to be done, or where the IV room is in the completion of that work.

In addition, a pharmacist by law has to approve each drug order before it can be released and delivered to a patient. Since this is a state regulated activity, there are a number of different rules and regulations imposed by the state on pharmacists in terms of the level of supervision required by a pharmacist in monitoring and approving drugs prepared by others. For example, a pharmacist may be able to approve a drug order and release it even if the pharmacist is in a different room of the same building; however, it is clear, that the pharmacist cannot approve a drug order from a remote location outside the building, such as, the home of the pharmacist or some other location. These rules and regulations can potentially limit the efficiency of the pharmacy since an order cannot be released until approved by a pharmacist and therefore, if the pharmacist is temporarily unavailable, etc., the order will be delayed.

### SUMMARY

The present disclosure generally relates to the management of medication dose orders. Specifically, the present disclosure may be utilized to manage dose order records maintained at a local server that are generated in response to receiving dose orders at a management system. The dose order records may be stored at the local server in corresponding relation to information regarding the received dose orders. The dose order records may include one or more dose order record data fields that may be populated with dose order metadata related to the dose order. The dose order metadata may be obtained from a received dose order (e.g., by way of a dose order entry system or the like) or may be associated with the dose order after receipt of the dose order (e.g., during the management, preparation, and/or distribution of the dose corresponding to the dose order).

In turn, management tools may be provided that provide users of the management tool the ability to manage pharmacy workflow or the like (e.g., with reference to the dose order records and/or information related to the dose order records such as dose order metadata). In particular, the management tools described herein may facilitate remote user participation in management of pharmacy workflow. For instance, the management tools described herein may be accessed via standard Internet protocol(s) (i.e., the management tools may include web-based management tools). In this regard, the management tool may communicate with the local server over a wide area communication network such as the Internet or may be in communication with the local server via a local area network such as a hospital Ethernet or the like. In either regard, the management tool may facilitate a user interface that may be accessed remotely from the pharmacy where dose orders are to be prepared.

Specifically, the management tool may provide a remote user the ability to access dose order records with respect to one or more stages of the pharmacy workflow. For instance, dose order records may include a status indicator (e.g., provided as dose order metadata for a corresponding given dose order record data field) that is indicative of the stage of the dose order record in a pharmacy workflow. Examples of statuses of dose orders include a status indicator for dose orders ready to be prepared at a workstation in the pharmacy (e.g., “at prep”), a status indicator for dose orders that have been prepared and are awaiting pharmacist review (e.g., “at checking”), a status indicator for dose orders that have been reviewed by a pharmacist and are ready for dispensation from the pharmacy (e.g., “at sort”), or other appropriate status indicators corresponding to a state of a dose order relative to a pharmacy workflow. In turn, the management tool may provide a remote user the ability to view, modify, or otherwise manage dose order records at any one or more states of pharmacy workflow (e.g., including dose order records corresponding to dose orders that have not yet been prepared as well as dose orders corresponding to dose orders that have been prepared).

To assist in facilitating the viewing, modifying, or other management activity, the management tool may allow a remote user to filter dose order records obtained from a dose order queue maintained at the local server such that selected ones of the dose order records are displayed to the user in a dose order record listing at the management tool. Such filtering may be based at least in part on a status of the dose corresponding to a dose order relative to a pharmacy workflow or based on any other one or more portions of dose order metadata associated with the dose order records. Furthermore, the dose order record listing may be modified to include different portions of metadata related to dose order records displayed in the dose order record listing.

As noted, the management tool may allow for viewing, modifying, and/or otherwise managing dose orders in various states of the pharmacy work flow. For example, dose order records may be modified by the management tool such that one or more portions of dose order metadata may be changed including, for example, changing a status of the dose order, changing an administration time of the dose order, changing a patient location associated with the dose order, changing a priority of the dose order, placing the dose order on hold, placing the dose order into a wait status, or otherwise adding, removing, or changing dose orders or dose order metadata.

Furthermore, the present disclosure includes rule based management of dose order records. In this regard, a dose logic engine (“DLE”) may be provided to execute one or more rule based operations relative to dose order records. For instance, the DLE may be operative to access dose order records (e.g., dose order metadata in dose order record data fields that are associated with dose orders) and apply one or more rules (e.g., execute an operation) based on the dose order record and/or dose order metadata regarding a dose order record. For instance, the DLE may be used to identify potential duplicate dose order records, identify discontinued dose order records, or other operations that may be used to manage dose orders. Furthermore, rule based management of dose orders may be used to assist in tracking dose orders. One such example are transport collection rules that may allow for rule based management of the aggregation of dose orders into transport collections for distribution from the pharmacy.

Accordingly, a first aspect includes a method for remote access of a system for management of medication dose orders. The method may include establishing operative communication between a terminal and a server that stores a plurality of dose order records corresponding to dose orders received at the server. The terminal may be remote from the server. The method may further include accessing the server using the terminal to retrieve a plurality of dose order records from the server. The plurality of dose order records may include at least a first dose order record corresponding to a first dose order that has not been prepared and at least a second dose order record corresponding to a second dose order that has been prepared and has not been verified by a pharmacist. The method may further include displaying the plurality of dose order records to a user at the terminal.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For example, in an embodiment the server may include a local server disposed at a pharmacy location. As such, the establishing operative communication may include internet communications between the terminal and the server. That is, the server and the terminal may be facilitated by communications using the Internet Protocol (e.g., TCP/IP) and/or any appropriate communication protocol and/or language (e.g., http, html, JavaScript, etc.). In this regard, the terminal may be a web browser user interface that may be executed by a web browser or the like. Accordingly, the displaying may include presenting the plurality of dose order records to the user using the web browser user interface. The dose order records may be displayed to the user as a dose order record listing. As such, the terminal may comprise a thin client in operative communication with the server to facilitate functionality described herein.

In an embodiment, the presenting may include filtering the plurality of dose order records displayed to the user (i.e., filtering the dose order record listing for display at the terminal). The filtering may be based on any one or more of a number of parameters. In an application, the filtering may be at least partially based on a status of the dose order records (e.g., relative to a pharmacy work flow). For instance, the status upon which the orders are filtered may be relative to whether the dose order record has been prepared or is awaiting pharmacist verification. In an application, the filtering may be at least partially based on a priority value of the plurality of dose order records (e.g., with priority values of first dose, STAT dose, wait, hold, or other priority indicators). In an application, the filtering may be at least partially based on dose order metadata contained in one or more dose order record data fields. In this regard, the dose order record listing may be filtered to display results that match selected parameters related to dose order metadata from one or more dose order record data fields for display to the user in the dose order record listing.

In an embodiment, the method may include modifying at least one dose order record of the plurality of dose order records at the terminal. For instance, the modifying may include changing a status of the at least one of the dose order records. The changing may include changing a hold status of the at least one of the dose order records. The changing may include discontinuing a dose order. The changing may also include modifying dose order metadata comprising one or more of a priority value, a patient location value, a nursing unit value, an administration time value, or a combination thereof. Furthermore, the changing may include modifying any other portion of dose order metadata regarding any dose order. However, the modification may be provided at least partially based on a prior value of the portion of the dose order to be modified (e.g., only a dose order with a hold status may be taken off hold) or may be at least partially based on user rights of the user attempting to make the change (e.g., only authorized users may make certain changes to dose orders and/or given portions of the dose order record such as specific ones of the dose order record data fields).

In an embodiment, the changing of a dose order record may include providing a reason for the changing of the at least one of the dose order records. Providing the reason may include selecting a predetermined reason from a plurality of predetermined reasons or a user may enter a reason not contained in the plurality of predetermined reasons (e.g., in a provided free form text entry field). In this regard, a plurality of predetermined reasons may be provided for selection by a user and/or text entry may be provided by the user. In an application, upon entry of a reason in a text entry field, the text provided by the user may be added to the predetermined reasons to be provided (e.g., based on the user identity, user rights, etc.).

In an embodiment, the method may include accessing a dose order being verified by another user. That is, when a dose order is selected for verification by a user, a status of the dose order record corresponding to the dose order begin verified may be changed to indicate a user has access to the dose order for purposes of verification. For various reasons it may be beneficial to allow for interruption of such access by a user to the dose order. In this regard, the method may include modifying control of the dose order being verified by the another user. For instance, the modifying may include revoking control of the dose order from the another user. Furthermore, the modifying may include taking control of the dose order at the terminal from the another user.

It may be beneficial to provide an indication to a user of the terminal that the status of one or more dose order records and/or a dose order record listing including a dose order record has been changed upon receipt of updated dose orders of the terminal from the server. As such, the method may include updating a graphical user element at the terminal in response to a dose order record being added to the plurality of dose order records. Such an indication may be recognized at the terminal in response to a change in a dose order record listing. For instance, the terminal may periodically refresh the dose order record by periodically requesting dose order records from the server. Upon such a refresh, the provision of new data from the server, as determined at the terminal, may result in the indication being provided to a user. In an application, the dose order record added to the plurality of dose order records that results in an indication may be a high priority dose order (e.g., a first dose, a STAT dose, etc.). Furthermore, the updating may include changing a color of at least a portion of graphical user element displayed at the terminal.

In an embodiment, the method may include viewing dose order record metadata contained in one or more dose order record data fields for at least one dose order record. For instance, a dose order record may be selected from a dose order record listing by a user. In response to the selection, the dose order metadata for the selected dose order record may be presented to the user. For example, the dose order metadata may be displayed in corresponding relation to dose order record data fields with which the dose order metadata is associated. Additionally or alternatively, one or more portions of dose order metadata may be presented to the user in the dose order record listing (e.g., as delineated columns of information that may be selectable by the user). In an application, a user may view dose order metadata for at least one dose order record that has been generated by the server and not released for preparation at the pharmacy. As such, the method may further include releasing the at least one dose order record for preparation at the pharmacy (e.g., after a preliminary review of the dose order at the terminal).

As described above, the dose order record listing may include records presented as rows with columns Provided that correspond to different portions of dose order metadata for each respective dose order record listed in the rows. As such, the displaying may include presenting the user a dose order record listing at the terminal. The method may further include selecting a dose order record data field for categorization of dose order records in the dose order record listing. In turn, the method may include presenting the dose order records in a categorized manner according to a dose order record data field, wherein each one of the dose order records that include corresponding dose order metadata for the dose order record data field that are grouped in the dose order record listing according to the corresponding dose order record metadata.

A second aspect may include a system for remote access to and management of medication dose orders. The system may include a remote access terminal remote from and in operative communication with a server. The server may store a plurality of dose order records corresponding to dose orders received by the server. In turn, the remote access terminal may be operative to access the server to retrieve a plurality of dose order records from the server at least including a first dose order record corresponding to a first dose order that has not been prepared and at least a second dose order records corresponding to a second dose order record that has been prepared and has not been verified by a pharmacist. The system may further include a user interface provided at the remote access terminal for displaying a dose order record listing to a user including at least one of the first dose order record or the second dose order record.

A number of feature refinements and additional features are applicable to the second aspect. These feature refinements and additional features may be used individually or in any combination. As such, each of the features below that will be discussed or any of the features described above in relation to the first aspect may be, but are not required to be, used with any other feature or combination of features of the second aspect.

For instance, the system of the second aspect may include one or more modules executable to provide functionality as described above. These modules may comprise software, hardware, or a combination of both. For instance, the modules of the system may include specifically configured hardware such as application specific integrated circuits (ASICs), programmable field gate arrays, or other appropriate processors. In an embodiment, the modules may include a microprocessor in operative communication with a memory. The memory may comprise a non-transitory computer readable medium that may include machine-readable instructions. As such, the processor may access the memory and be configured by the machine-readable instructions stored therein to execute any of the functionality described herein. For instance, any of the functionality described in the method of the first aspect above may be provided by the system of the second aspect.

A third aspect includes a method for management of dose order records corresponding to medication dose orders with suspected duplicate medication dose orders. The method may include storing a plurality of dose order records at a database. Each dose order record may be stored in corresponding relation to one or more dose order record data fields populated with dose order metadata regarding each dose order record. The method may further include identifying a first dose order record and comparing dose order metadata regarding the first dose order record with corresponding portions of dose order metadata from the plurality of dose order records in the local database. In turn, the method may include determining a predetermined correspondence between the dose order metadata regarding the first dose order record and the dose order metadata regarding at least one other dose order record of the plurality of dose order records. The method may further include associating the first dose order record with the at least one other dose order record in response to the determining and presenting to a user an indication that the first dose order record is potentially a duplicate of the at least one other dose order record.

A number of feature refinements and additional features are applicable to the third aspect. These feature refinements and additional features may be used individually or in any combination. As such, each of the following features that will be discussed may be, but are not required to be, used with any other feature or combination of features of the third aspect.

In an embodiment, the first dose order record corresponds to a new dose order record corresponding to a dose order received at the database. Thus, the method may be performed relative to the new dose order record upon receipt at a management tool from a dose order entry system or the like. Additionally or alternatively, the method may be performed in response to other conditions being satisfied such as, for example, upon a request to execute the method by a user, upon a change in status of a dose order record, on a predetermined periodic basis, or at some other condition.

In an embodiment, the predetermined correspondence may be configurable by an administrator of the database. In this regard, it may be appreciated that the predetermined correspondence may, but is not required to, define identical dose order records. That is, the predetermined correspondence may include each and every portion of dose order metadata in each and every dose order record data field for the first dose order and the at least one other dose order record match identically. However, in other embodiments, the predetermined correspondence may include less than identical dose order records. In this regard, the predetermined correspondence may correspond to less than all of the dose order record metadata for the first dose order record and the at least one dose order record matching identically. For instance, the user may define one or more dose order record data fields that must contain matching dose order metadata between the first dose order record and the at least one other dose order record. Furthermore, the predetermined correspondence may include less than identical matches for those portions of dose order metadata of the first dose order record and the at least one other dose order record. That is, the predetermined correspondence may define a minimum similarity between portions of dose order record metadata that is less than identical.

In an embodiment, the presenting may include displaying the first dose order record in associated relation to the at least one other dose order record. The method may further include soliciting a user to verify the first dose order record is a duplicate of the at least one other dose order record. The soliciting may include providing the user at least a first selection that confirms the first dose order record is a duplicate of the at least one other dose order record and a second selection that denies the first dose order record is a duplicate of the at least one other dose order record. As such, the method may be utilized to identify suspected duplicates based on the predetermined correspondence. In turn, the presentation of the suspected duplicates may be confirmed or denied by the user. Thus, upon selection by the user of the first selection confirming the suspected duplicate, the first dose order record may be removed from a dose order record listing so that the first dose order record is not visible at a preparation station in operative communication with the database. In contrast, upon selection by the user of the second selection denying the suspected duplicate, the first dose order records is disassociated from the at least one other dose order record, and the first dose order record is added to a dose order record listing so that the first dose order record is visible at a preparation station in operative communication with the database. In an embodiment, the presenting may be in response to a scan event corresponding at least one of to the first dose order record or the at least one other dose order record.

A fourth aspect includes a system for management of dose order records corresponding to medication dose orders with suspected duplicate medication dose orders. The system may include a database that stores a plurality of dose order records that are each stored in corresponding relation to one or more dose order record data fields that are populated with dose order metadata regarding each respective dose order record. The system may also include a dose logic engine in operative communication with the database. The dose logic engine may include logic to compare dose order metadata regarding a first dose order record with corresponding portions of dose order metadata from a plurality of other dose order records in the database, determine a predetermined correspondence between the dose order metadata regarding the first dose order record and the dose order metadata regarding at least one other dose order record of the plurality of dose order records, and associate the first dose order record with at least one other dose order record in response to the determining. The system further includes a user interface in operative communication with the dose logic engine to present to a user an indication that the first dose order record is potentially a duplicate of the at least one other dose order record.

A number of feature refinements and additional features are applicable to the fourth aspect. These feature refinements and additional features may be used individually or in any combination. As such, each of the features below that will be discussed or any of the features described above in relation to any of the foregoing aspects may be, but are not required to be, used with any other feature or combination of features of the fourth aspect.

For instance, the system of the fourth aspect may include one or more modules executable to provide functionality as described above. These modules may comprise software, hardware, or a combination of both. For instance, the modules of the system may include specifically configured hardware such as application specific integrated circuits (ASICs), programmable field gate arrays, or other appropriate processor types. In an embodiment, the modules may include a microprocessor in operative communication with a memory. The memory may comprise a non-transitory computer readable medium that may include machine-readable instructions. As such, the processor may access the memory and be configured by the machine-readable instructions to execute any of the functionality described herein. For instance, any of the functionality described in any foregoing aspect may be provided by the system of the fourth aspect.

A fifth aspect includes a method for management of dose order records corresponding to discontinued medication dose order records. The method may include storing a plurality of dose order records in a database. Each dose order record may be stored in corresponding relation to one or more dose order record data fields populated with corresponding dose order metadata regarding each dose order record. The method may further include receiving a discontinued dose order at the database and comparing dose order metadata regarding the discontinued dose order record with corresponding portions of dose order metadata from the plurality of dose order records in the local database. In turn, the method may include determining a predetermined correspondence between the discontinued dose order record and at least one other dose order record of the plurality of dose order records and associating the discontinued dose order with the at least one other dose order record in response to the determining. Thus, the method may include changing a status of the at least one other dose order record from a current status to a discontinued status in response to the determining.

A number of feature refinements and additional features are applicable to the fifth aspect. These feature refinements and additional features may be used individually or in any combination. As such, each of the following features that will be discussed may be, but are not required to be, used with any other feature or combination of features of the fifth aspect.

For example and in an embodiment, the at least one other dose order record may have not yet been prepared. In this case, the method may additionally include removing the at least one other dose order record from the database (e.g., from a dose order queue). In an embodiment, the at least one other dose order record may have already been prepared at the time of receipt of the discontinued dose order. In this regard, the method may further include removing the at least one other dose order record from the database (e.g., from a base order queue) and storing the prepared dose as a product corresponding to a work in progress entry in the database.

A sixth aspect may include a system for management of dose order records corresponding to discontinued medication dose order records. The system may include a database that stores a plurality of dose order records that are each stored in corresponding relation to one or more dose order record data fields that are populated with dose order metadata regarding each respective dose order record. The system may further include a dose logic engine in operative communication with the database. The dose logic engine may include logic to compare dose order metadata regarding a discontinued dose order record with corresponding portions of dose order metadata from the plurality of dose order records in the database, determine a predetermined correspondence between the discontinued dose order record and at least one other dose order record of the plurality of dose order records, associate the discontinued dose order with the at least one other dose order record in response to the determining, and change a status of the at least one other dose order record from a current status to a discontinued status in response to the determining.

A number of feature refinements and additional features are applicable to the sixth aspect. These feature refinements and additional features may be used individually or in any combination. As such, each of the features below that will be discussed or any of the features described above in relation to any of the foregoing aspects may be, but are not required to be, used with any other feature or combination of features of the sixth aspect.

For instance, the system of the sixth aspect may include one or more modules executable to provide functionality as described above. These modules may comprise software, hardware, or a combination of both. For instance, the modules of the system may include specifically configured hardware such as application specific integrated circuits (ASICs), programmable field gate arrays, or other appropriate processor types. In an embodiment, the modules may include a microprocessor in operative communication with a memory. The memory may comprise a non-transitory computer readable medium that may include machine-readable instructions. As such, the processor may access the memory and be configured by the machine-readable instructions to execute any of the functionality described herein. For instance, any of the functionality described in any foregoing aspect may be provided by the system of the sixth aspect.

A seventh aspect includes a method for management of transport collections for medication dose orders. The method may include defining a transport collection. The transport collection may correspond to a destination for delivery of medication dose orders associated with the transport collection. Furthermore, the method may include storing a plurality of dose order records in a database. Each dose order record may be stored in corresponding relation to one or more dose order record data fields populated with corresponding dose order metadata regarding each dose order record. The method may further include maintaining at least one transport collection rule relative to the transport collection. The at least one transport collection rule may define acceptable dose metadata for one or more dose order data fields for inclusion of the dose order in the transport collection. For instance, only dose orders with the acceptable dose order metadata for the one or more dose order record data fields may be acceptable for addition to the transport collection.

A number of feature refinements and additional features are applicable to the seventh aspect. These feature refinements and additional features may be used individually or in any combination. As such, each of the features below that will be discussed or any of the features described above in relation to any of the foregoing aspects may be, but are not required to be, used with any other feature or combination of features of the seventh aspect.

In an embodiment, the method may include receiving a request to add a first dose order to the transport collection and scrutinizing dose order record data fields of the first dose order record relative to the at least one transport collection rule. In turn, the method may include determining the dose order record data fields for the first dose order comprise acceptable dose order metadata in accord with the at least one transport collection rule and associating the first dose order record with the transport collection.

In an embodiment, the method may include receiving a scan event for the transport collection comprising an indication of a change in location in the transport collection. In turn, the method may include automatically updating a location for a plurality of dose orders associated with the transport collection in response to the receiving, wherein none of the dose orders are scanned individually with respect to the scan event.

An eighth aspect may include a system for management of transport collections for medication dose orders. The system may include a database that may be operative to store a plurality of dose order records. Each dose order record may be stored in corresponding relation to one or more dose order record data fields populated with corresponding dose order metadata regarding each dose order record. The system may further include an indicia disposed relative to a location corresponding to a destination for delivery of one or more dose orders. Furthermore, the system may include a transport collection logic module operative to apply at least one transport collection rule to an attempted association between a dose order record and the location based at least in part upon a definition of acceptable dose metadata for one or more dose order data fields, wherein only dose orders with the acceptable dose order metadata for the one or more dose order record data fields are acceptable for association with the location. The system may in turn include a transport collection comprising a plurality of associated doses stored at the location and logically associated with the location.

A number of feature refinements and additional features are applicable to the eighth aspect. These feature refinements and additional features may be used individually or in any combination. As such, each of the features below that will be discussed or any of the features described above in relation to any of the foregoing aspects may be, but are not required to be, used with any other feature or combination of features of the eighth aspect.

For instance, the system of the eighth aspect may include one or more modules executable to provide functionality as described above. These modules may comprise software, hardware, or a combination of both. For instance, the modules of the system may include specifically configured hardware such as application specific integrated circuits (ASICs), programmable field gate arrays, or other appropriate processor types. In an embodiment, the modules may include a microprocessor in operative communication with a memory. The memory may comprise a non-transitory computer readable medium that may include machine-readable instructions. As such, the processor may access the memory and be configured by the machine-readable instructions to execute any of the functionality described herein. For instance, any of the functionality described in any foregoing aspect may be provided by the system of the eighth aspect.

Furthermore, the system may include a reader that is operative to read the indicia disposed relative to the location. The reader may be operative to receive a request to add a first dose order to the transport collection. The transport collection rule module may be operative to scrutinize dose order record data fields of the first dose order record relative to the at least one transport collection rule and determine the dose order record data fields for the first dose order comprise acceptable dose order metadata in accord with the at least one transport collection rule to associate the first dose order record with the transport collection. As such, a scan event for the transport collection may be an indication of a change in location in the transport collection and may automatically update a location for a plurality of dose orders associated with the transport collection.

### BRIEF DESCRIPTION OF THE DRAWING FIGURES

FIGS. 1 and 1A illustrate a process for receiving, processing, and preparing medication dose orders in accordance with one embodiment of the present invention;

FIG. 2 illustrates a process for managing, approving and distributing prepared medication doses in accordance with an embodiment of the present invention;

FIG. 3 illustrates an operating environment in accordance with an embodiment of the present invention;

FIG. 4 illustrates a database and server arrangement for the preparation and management of medications in accordance with an embodiment of the present invention;

FIG. 5 is an exemplary display of a situation board that is part of the operating environment for displaying overall status summary information about current operations within the pharmacy;

FIG. 6 is a dialog box showing an incoming, processed drug order that needs filling;

FIG. 7 is a dialog box showing details concerning a preselected drug order;

FIG. 8 is an exemplary display of a dose verification screen for verifying that the prepared dose is the proper, intended dose of medication;

FIG. 9 is an exemplary display of a dose preparation screen and procedure;

FIG. 10 is an exemplary display of a product preparation screen and procedure;

FIG. 11 is a schematic overview of management and reporting of medication preparations in accordance with a broad aspect of the invention; and

FIG. 12 is an exemplary display of a product information screen;

FIG. 13 is an exemplary display of a login screen for an embodiment of a dose order management tool;

FIG. 14 is an exemplary display of a navigation screen for an embodiment of a dose order management tool;

FIG. 15 is an exemplary display of a dose order management screen for an embodiment of a dose order management tool;

FIG. 15A is an exemplary display of a dose order modification dialogue box for an embodiment of a dose order management tool;

FIGS. 16-19 are exemplary displays of a dose order management screen with filtered dose order record listings;

FIG. 19A is an exemplary display of a verification control dialogue box for an embodiment of a dose order management tool; and

FIGS. 19B and 19C are exemplary displays of dose verification screens.

### DETAILED DESCRIPTION

The present disclosure relates to the capture, processing, tracking, approval and distribution of medications. More particularly, the disclosure relates to an at least partially automated fulfillment system and method for receiving incoming medication dose orders, and processing those orders, preferably in an efficient and optimized manner. Specifically discussed herein is the use of a remote access terminal for access to a local database for viewing, modification, verification, or other appropriate management functions to be performed relative to the local database from the remote access terminal. Furthermore, a rule-based approach to dose order management is described that may be used to assist in the management of dose orders. Optionally, each prepared medication dose can be tracked through to its predetermined destination. Accordingly, the present disclosure further presents transport collections that may be useful in efficiently collectively tracking a plurality of dose orders to the predetermined final destination. In addition, the present invention relates to software-based systems that operate to provide a portal for dose inspection that facilitates the practice of telepharmacy including remote review and/or management of dose orders and/or remote verification of dose preparations in relation to dose orders.

As will be appreciated in the following description, the present disclosure describes a remote pharmacist workspace management tool. This remote pharmacist workspace management tool may provide an interface for a remote user (e.g., a pharmacist located remotely from the pharmacy and/or remote from the facility housing the pharmacy) to assist in management of a plurality of dose orders as reflected in a dose order queue. The remote pharmacist workspace management tool may allow the remote user to manage dose orders that have yet to undergo preparation and/or that have been prepared. As will be apparent in the discussion below, the ability for a remote pharmacist to assist in management of the dose order queue of a facility may assist the remote pharmacist in management of pharmacy workflow, provide increased efficiency of verification by the remote pharmacist, and facilitate improved control over the dose order queue.

Additionally described herein is an embodiment of a dose management tool referred to herein as a dose logic engine (“DLE”). The DLE may facilitate a rule-based approach to at least some management functions related to dose orders. For instance, the DLE may include one or more dose management rules that may assist in management of pharmacy workflow and/or dose order queue management. The dose management rules of the DLE may scrutinize one or more portions of metadata related to each respective dose order record in a dose order queue. In turn, the DLE may, for example, be operative for duplicate dose order detection, discontinued dose order detection, automatic preparation mode assignment, or other operations applied to one or more dose order records.

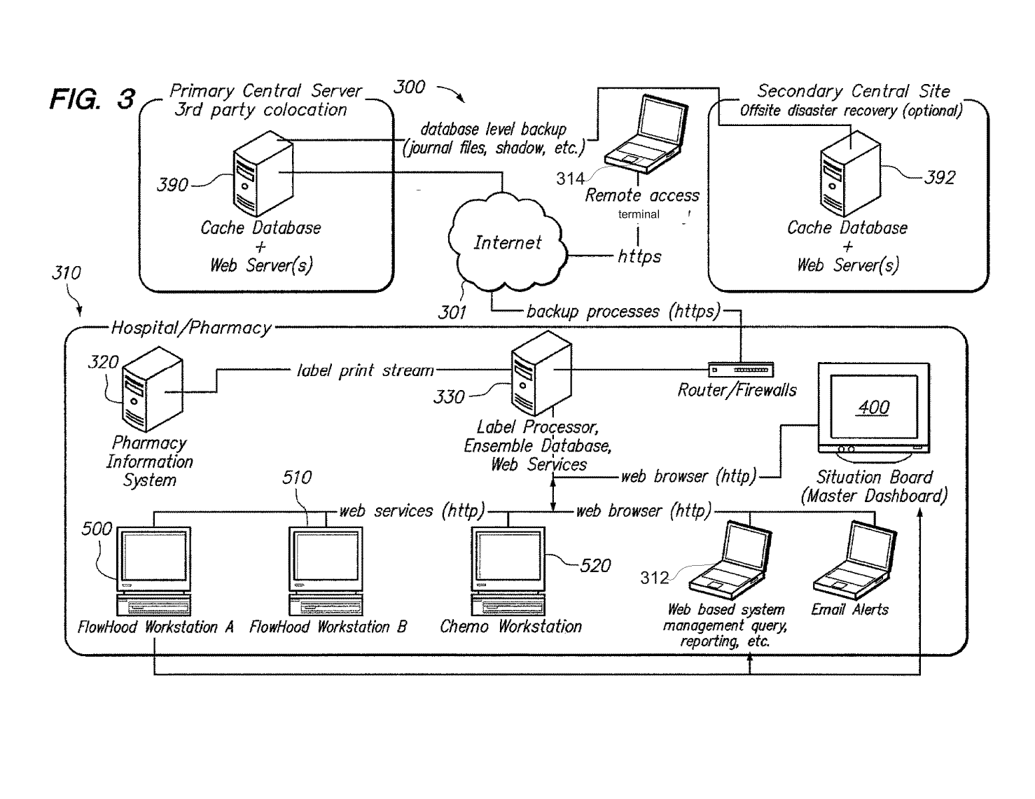

By way of overview and example, a doctor or another person can enter one or more medication orders (“medication order”) at a terminal in a hospital or a pharmacy 310, such as through a conventional pharmacy information system 320 as shown in FIG. 3. In addition, one or more medication orders can be entered through a terminal that is at a remote location and these orders can be delivered though a network (e.g., Internet), as described below, to a local server 330 (discussed below) where they are processed in the same manner as any orders entered directly into a terminal within the hospital or pharmacy.

When the order is processed by the pharmacy information system 320 and labels for the medication doses are generated, the data contained in the order and on the labels may be captured, processed, and parsed by the computer implemented system to create individual medication dose orders (“dose orders”) and associated database records in the form of dose order records. The dose order records may include one or more dose order record data fields that may be populated with data parsed from data comprising the order (e.g., received from the pharmacy information system 320) and/or supplemental data that may be manually entered regarding the dose order. Accordingly, the dose order record data fields may comprise dose order metadata regarding the dose order record. The dose order metadata may include one or more of the following types of data in corresponding ones of the dose order record data fields:
dose order status information indicative of at least one of:
   a preparation status of the dose order (e.g., pending, at preparation station, ready for verification, undergoing verification, approved, rework, requeue, awaiting sort, discontinued, etc.),
   a priority status of the dose order (e.g., STAT, first dose, etc.),
   a wait status (e.g., including a time at which the dose order become available to be made),
   a hold status,
dose order administration data indicative of at least one of:
   a patient to whom the dose order is to be administered,
   a time of administration (e.g., including date and time of administration),
   a beyond use date (BUD) indicative of an expiration (e.g., time and/or date) of the dose order,
   an administration route of the dose order,
   a preparation mode of the dose order,
dose order identification information indicative of at least one of:
   a dose order identifier (e.g., a dose order record number),
medication source data indicative of at least one of:
   a manufacturer of a component of a product corresponding to the dose order,
   a lot number of a component of a product corresponding to the dose order,
   an expiration date of a component of a product corresponding to the dose order,
   a serial number of a component of a product corresponding to the dose order, or
   a drug code indicative of the identity of a component of a product corresponding to the dose order;
chain of custody data indicative of at least one of:
   a listing of entities in possession of a component of a product corresponding to the dose order or a product corresponding to the dose order,
   a listing of users that have taken an action with respect to a product corresponding to the dose order, wherein the listing of users is correlated to specific actions taken by each user, or
   tracking information corresponding to physical movement of a component of a product corresponding to the dose order or a product corresponding to the dose order;
fulfillment data indicative of at least one of:
   image data corresponding with a component of a product corresponding to the dose order or a product corresponding to the dose order,
   scanned data obtained from a component of a product corresponding to the dose order,
   analytic data regarding a component of a product corresponding to the dose order or a product corresponding to the dose order,
   pharmacist review data corresponding with at least one pharmacist review of a component of a product corresponding to the dose order or a product corresponding to the dose order,
   compliance data corresponding with best practices associated with a component of a product corresponding to the dose order or a product corresponding to the dose order,
   sterility assessment data corresponding to a component of a product corresponding to the dose order or a product corresponding to the dose order,
   a listing of actions corresponding to a component of a product corresponding to the dose order or a product corresponding to the dose order,
   time stamp data corresponding to actions corresponding to a component of a product corresponding to the dose order or a product corresponding to the dose order, or
   a listing of life cycle events taken with respect a component of a product corresponding to the dose order or a product corresponding to the dose order; or
environmental data indicative of at least one of:
   a temperature to which a component of a product corresponding to the dose order or a product corresponding to the dose order has been exposed,
   a temperature to which and corresponding time period for which a component of a product corresponding to the dose order or a product corresponding to the dose order has been exposed,
   whether a component of a product corresponding to the dose order or a product corresponding to the dose order is refrigerated,
   whether a component of a product corresponding to the dose order or a product corresponding to the dose order is frozen,
   a temperature profile experienced by a component of a product corresponding to the dose order or a product corresponding to the dose order, or
   accelerometer data corresponding to forces experienced by a component of a product corresponding to the dose order or a product corresponding to the dose order.

The software that operates in the local server 330 manages the dose order processing and generates a dose order queue that can be sorted and/or filtered in any number of different ways as described below. In this regard, the dose order queue may be displayed to a user as a dose order record listing. The dose order record listing presented to a user may be dependent upon one or more filters applied to the dose order queue. That is, the dose order queue may refer to the complete list of dose order records maintained at the database, while the dose order record listing may comprise the dose order records actually presented to a user at any given time.

The dose orders can be distributed to various compounding workstations such as workstations 500, 510, 520 in FIG. 3 (e.g., automated sterile compounding stations or manual processing stations) preferably in an optimized manner, as described below. The dose order queue may also be viewed, modified, and/or managed via a terminal 312 within the hospital or pharmacy 310 and/or a remote access terminal 314 in communication with the pharmacy 310 by way of the internet 301 (e.g., as operated by a remote pharmacist or the like). In any regard, the pharmacy terminal 312 or remote access terminal 314 may be in operative communication with the local server 330 (e.g., by way of a web based protocol and/or language such as hypertext transfer protocol (http), JavaScript, or other appropriate protocol) as shown in FIG. 3 and as will be described in greater detail below. At each stage of the dose order processing, the dose order record associated with the dose order can be updated to reflect its status and location. Furthermore, dose order record data fields or the dose order metadata contained therein may be modified, updated, or deleted.

Once the medication order is fulfilled, the resulting dose order is labeled, preferably at the dose preparation station so that the label is in close proximity to the prepared dose (as opposed to the conventional practice of centralized printing of all of the labels for dose-orders that enter the pharmacy), and more preferably is labeled so as to associate it with a patient care location. As described below, in one aspect of the present invention, a situation board 400 provides a view to all personnel in the pharmacy as to the status of each dose order record using metrics that have been established for display on the situation board.

In accordance with one aspect of the present invention, the dose orders that are received internally through terminals 312 onsite or externally through remote access terminals 314 are all delivered and processed at a local server 330 that includes a label processing module, a local database, web services, and software for managing the status of the doses through the entire system. For example, the local database 330 can be hosted locally at a site, such as a hospital, and this local server stores a rolling cache of the current in-process work as well as a history of past orders (e.g., 30-45 day history). A situation board 400 is in communication with the local server and is configured to maintain a high-level view of the work that immediately instructs an observer regarding incomplete work and further allows identification of work that is pending, under preparation or prepared but not yet reviewed by a pharmacist. The situation board 400 may also maintain alarms for doses that are past due, as well as tracking doses whose preparation must be delayed because of limited stability in solution.

As mentioned above, each dose order may have an associated dose order record having one or more dose order record data fields. The association between the dose order and the dose order record may be a result of linking the interrogation of a scanable element to the dose order record. A code supported by or secured to the dose itself and a code associated with a bin at the dosage form's current location can both be interrogated and then that information uploaded to a database. For example, the codes can be bar codes and can be sensed using a reader such as, for example, a bar code scanner. The particular scanner or reader used and the manner of scanning can be varied within the context of the invention to suit the requirements of a given implementation. Thus, for example, the code can be an optically scanable bar code or an interrogatable code such as an RFID tag that is supported in lieu of or in addition to bar codes, plain text, or other codes. The terms scanner, scanning, and scanable and/or reader, reading, or readable are intended to include wireless interrogation or passive data reception whether they are based on an optical read, a radio frequency interrogation or an interrogation in some other frequency band, or a form of passive wireless data reception. More generally, the codes in scanable or readable form are referred to as “tags.” As the dose is transported through the hospital to its final location, the bin can be scanned and any new location is scanned at various points to track its progress through the hospital.

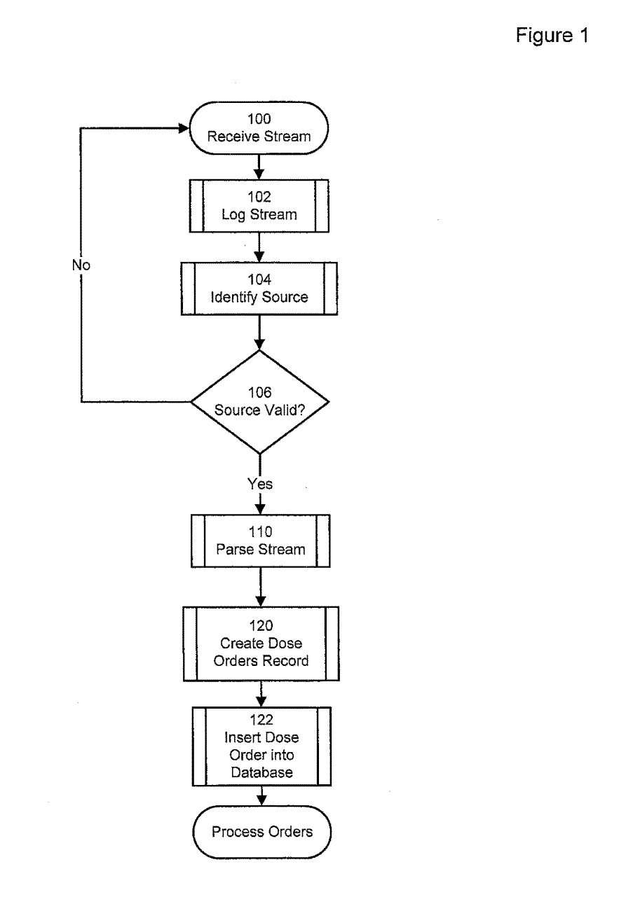

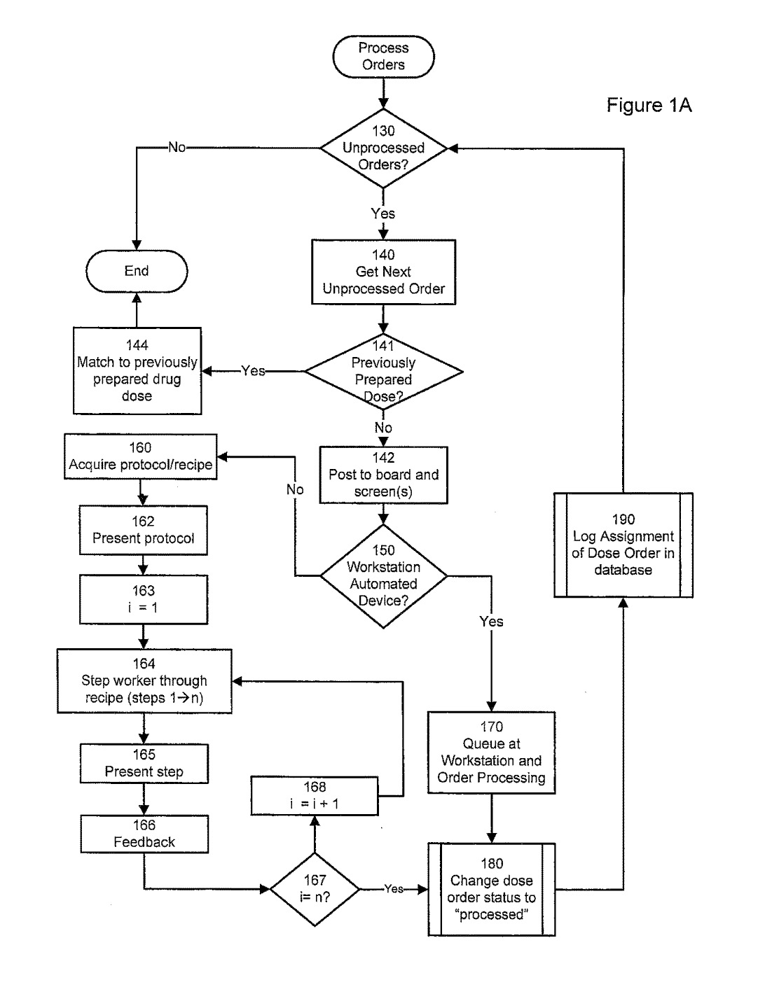

With reference now to FIG. 1, a process is illustrated by which dose orders are received, processed, and distributed within the pharmacy or medication preparation center. At step 100, medication order streams are received by the pharmacy and are processed by a label processing module that comprises code that executes in a machine such as the local server 330 to perform the processes in FIG. 1. Order streams can be received through various methods. For example, a medication order can be entered into a computer terminal within the pharmacy itself (e.g., by way of a pharmacy information system 320), at a computer terminal in communication with the pharmacy over a local network (e.g., access terminal 312), or at a device that is communicatively connected to the pharmacy from a remote location (e.g., remote access terminal 314). Alternatively, the medication data can be captured by a monitoring module comprising computer code executing in the pharmacy for monitoring of, say, a port normally connected to a pharmacy printer, network monitoring for medication order information, or software application monitoring for events related to the input of medication orders. Traditionally these order streams represent data intended to be printed on labels on a printer, and oftentimes comprise serial data streams.

Medication order streams may contain a list of medication doses to prepare. Each dose order and dose is preferably associated with additional related data such as, for example, the patient for whom the medication is intended, by when it should be delivered, and to where it should be delivered or any other appropriate metadata described above that may be present in the mediation order stream. Such information may be used to populate appropriate dose order record data fields in corresponding ones of the dose order records that correspond to respective ones of the dose orders. Additional dose order metadata may also be associated with the dose order including the prescribing doctor, the time and date the prescription was entered, the reason for medication, and other relevant information frequently recorded and associated with a prescription, all of which may also be used to populate appropriate dose order record data fields in corresponding ones of the dose order records that correspond to respective ones of the dose orders. Furthermore, dose order metadata as described above may be stored in corresponding dose order record data fields for each dose order.

Data streams containing medication dose data are preferably logged at step 102 by a monitoring computer. Preferably, streams are logged in a database or other computer accessible medium. Logging data streams enables extensive auditing and monitoring of the pharmacy—or hospital—dispensed medication. Because all data is logged, preferably in its raw form when it is first received by the pharmacy, no information is lost, corrupted, or disassociated during the processing or distribution of the medication. If necessary, an audit can be performed manually, off-line, or by a separate software program to reconstruct the data stream and all processing that should have or did occur after the pharmacy received the data stream. Furthermore, the logged data can be analyzed with respect to dose order demand. The average volume, peak volume, and standard deviation of dose orders can be determined for various historical time periods (e.g., day of the week, month, last week, last month, etc.). Based on this analysis, decisions regarding the required staffing to fulfill the expected volume of dose orders can be made.

Preferably, the data stream has an identifiable source. The source can be explicitly identified within the stream of data, or it can be determinable by the fulfillment system. Source determination can include, for example, examining TCP/IP packet or its header/footer information, examining cryptographic signatures of the stream, or data retrieved through additional network communication requesting the source. The source is identified at step 104.

At step 106, the fulfillment system can be configured to determine whether the data stream originated from one of a set of valid sources. This can include identifying the source of the data stream and testing that it is one of the sources among those in the set. Validating the source ensures each medication dose prepared by the fulfillment system is legitimate and originating from an authorized prescribing entity. Alternatively, the validation can ensure that the prescribing entity is presently entitled to have its prescriptions filled by the pharmacy. If the source is not valid, the fulfillment system returns to step 100 to receive additional streams. Optionally, notifications can be sent to the source to inform it that there were validation issues or that the window for continued validation has one or more constraints (e.g., will expire in so-many days due to an overdue invoice).

In one embodiment of the fulfillment system, the software executes in a multi-threaded or multi-process environment. Thus, multiple streams can be processed simultaneously, by including necessary memory and database locks to ensure consistency. While the fulfillment system is described above as returning to step 100 to receive additional streams, persons of skill in the art appreciate that streams can be received by a server thread and dispatched for processing to other threads within a thread-pool. Other multi-threaded or multi-process mechanisms can be used to control the processing of data streams received by the fulfillment system.

After determining that the source is valid, the stream is parsed to extract relevant information at step 110. The fulfillment system can parse various message and data formats. Moreover, the parser can be extensible, such that as new formats are implemented or included within the networked environment, a parser extension can be included in the fulfillment system to parse the new format. For example, if the data stream is a serial printer data stream, the fulfillment system can determine the format of the data and pass the stream to the appropriate serial printer data parser. The printer data parser is configured to extract the dose medication contained within the stream and may populate dose order record data fields with the parsed data from the dose order corresponding to any one or more of the portions of metadata described above. Preferably, the parser extracts all relevant data contained within the stream and maintains a record of the extracted data. The parsing methodology is preferably encapsulated in a library or set of modules that are called upon, as necessary, to parse a stream of any determined format. Each library entry or module operates as a “parser,” as that term is used herein.

The data stream can contain one or more dose orders. For example, the stream may contain a single prescription dose request by a doctor for a single patient. Alternatively, the stream can include multiple dose orders for batch processing. The parser is preferably configured to recognize and discriminate between individual dose orders within a stream. The discrimination of individual dose orders can be accomplished by recognizing an order delimiter, or alternatively can be defined by the format of the data stream.

The data extracted by the parser at step 110 is used to create a dose order record at step 120. A dose order record is preferably created for each individual dose order encoded by the data stream, and contains the information extracted from the stream in corresponding dose order record data fields for each dose order record created. That is, each individual dose order may have a corresponding dose order record that includes a plurality of portions of data (e.g., dose order metadata or the like) regarding the dose that are stored in dose order record data fields. At step 122 each dose order record can be stored in a database or other data storage system such as a suitable data-structure. For example, each dose order record may be stored in the local server 330. Furthermore, the portions of dose order metadata stored in relation to dose order record data fields for each dose order record may be stored in corresponding relation to each appropriate dose order record. Each dose order is preferably assigned a unique dose identifier that can be used to track the dose order and resulting dose through the fulfillment system.

A dose order monitoring application or module is operative at the local server 330 to track dose orders in the database and provide monitoring services such as to provide data that is displayed by the situation board 400. Furthermore, the dose monitoring application or module may provide information to a remote access terminal 314 for remote display and/or management of the dose order queue (e.g., by use of a web-based user interface or the like). As such, at this stage, the dose order can be included in the presentation output on the situation board 400, pharmacy terminal 312, and/or remote access terminal 314 to apprise persons in the pharmacy or at a remote location that another dose is in the queue for processing, and to apprise a supervisor or pharmacist of the change to the queue without requiring them to be in the pharmacy, as will be described further below. In addition to providing the dose queue for display (e.g., at the situation board 400), the dose queue may also be managed by, for example, by filtering the dose queue to present a dose order record listing, by overriding dose orders, by allowing review of dose orders, by reprioritizing dose orders, or by modifying the dose order record and/or dose order record data fields. Such management functions may be provided by way of a pharmacy terminal 312. Additionally, the remote access terminal 314 may allow for the viewing and/or management of dose orders in the foregoing manner by a remote user.

The above description outlines the steps by which medication data streams enter the pharmacy and may be pre-processed in anticipation of being filled by the pharmacy. Once the data streams have been processed, parsed into individual medication doses, and stored as dose records within the fulfillment system, the pharmacy can prepare the medication doses identified by each dose record at one or more workstations configured to permit preparation of medications, such as, for example, workstations 500, 510, 520.

In accordance with an aspect of the present invention the medication data streams can enter pharmacy through data entry at a local station or by being entered over a network at a remote location (see FIG. 3). The local server 330 includes a label processing module and a local database, for example, an Ensemble database). The local server receives dose-orders and performs the processing described above with reference to and illustrated in FIG. 1.

All dose orders are initially stored in the local database, such as the Ensemble database that is hosted locally at each site. A queue is generated for all received dose orders and, as described below, in accordance with one aspect of the present invention, the dose order queue can be displayed on a touch screen display at one or more workstations.

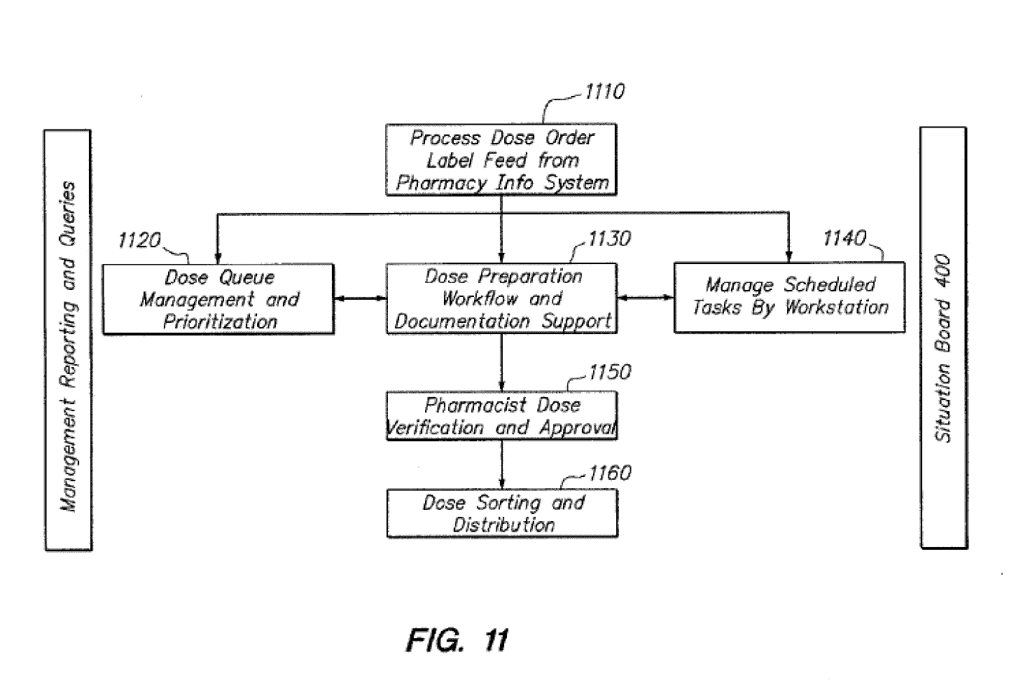

With reference briefly to FIG. 11, an overview of the dose management process is outlined in broad terms. At block 1110, a dose order received from a pharmacy or hospital information system 310 is processed substantially as described in connection with FIG. 1. Those dose orders define respective records in the local server 330 that are forwarded to applications executing at one or more workstations located within the pharmacy, hospital, or elsewhere. This workstation application or the technician responsible for operating the workstation has access to a dose queue and can prioritize and manage does order processing, as indicated at block 1120 to generate a dose order record listing. As mentioned above, the viewing, prioritization, and/or management of dose order processing may occur locally at the pharmacy 310 and/or by way of a remote access terminal 314 using a dose order management tool as described in greater detail below. In any regard, the workstation application or technician can manage the various open tasks (orders to fill) by interacting with the workstation in order to follow the protocol or “recipe” mandated for a particular dose order or batch of orders, as indicated at block 1140. The dose orders are prepared as final doses at the workstation with the benefit of documentation support, as indicated at block 1130. The document support is provided to the technician to guide preparation and better ensure that doses are prepared in accordance with established protocols and policies. As described further below, the intermediate steps in the preparation of each dose order are subject to data capture to permit post-preparation review of the steps taken to prepare each dose. Thus, as can be appreciated, blocks 1120, 1130, and 1140 are contemplated as being performed at one or more dose-preparation workstations. In the meantime, as schematically illustrated along the left and right margins of FIG. 11, the situation board 400 can present progress information and other metrics to assist in the orderly management of the pharmacy, while management modules can provide queries and report results of the progress as well as other metrics that concern the facility 310 as well as other facilities through an interface to the local server 330. At block 1150, the local server 330 receives through a connection such as a web service portal or other communicative link an approval or a denied message from a pharmacist upon his or her post-preparation review of the intermediate steps in the preparation of each dose order. At block 1160, sorting and distribution of the prepared medication doses to the intended recipient or for storage in anticipation of use completes the process.

Referring now to FIG. 1A, order fulfillment processing commences at step 130 at which a fulfillment module determines whether there are any unfulfilled dose order records in the database. The fulfillment module comprises code executing in a machine, and, more preferably, within the local server 330, and the label processing module can be part of the fulfillment module or the two modules can communicate with one another in the processing of dose orders. If no unfulfilled orders exist, the fulfillment module can redirect its resources to processing incoming data streams at step 100, or completing or processing any active thread, as indicated schematically by the “end” terminator in the flow chart. However, if unfulfilled dose order records are in the database, the fulfillment module will retrieve an unfulfilled dose order record at step 140. At decision 141, the fulfillment module can determine whether a dose was previously prepared and stored which would satisfy the dose order. For disclosure of a system that prepares dose orders in anticipation of need for such orders, see U.S. application Ser. No. 11/844,135, filed Aug. 23, 2007, entitled “Automated Centralized Preparation Of Medications In Anticipation Of Use,” which is hereby incorporated by reference as if set forth in its entirety herein. If no such dose exists, the dose order can be posted to the dose order queue at each workstation and is posted to the situation board 400 (sometimes referred to in the art as a “dashboard”) at step 142. Additionally, the dose order record may be updated so that a status of the dose order record is indicated as “pending” to signify the dose order is ready to be prepared. Optionally, the requirements for filling the dose order are retrieved and used to post the dose order to the dose order queues of only those workstations that are suitable for handling such a dose order. In this way, individual workstations can have a tailored queue of pending dose orders. In another arrangement, such tailored queues are provided to the individual workstations but the operator of such workstation can expand the presentation to see other dose orders in the queue even if not suitable for handling at the operator's workstation.

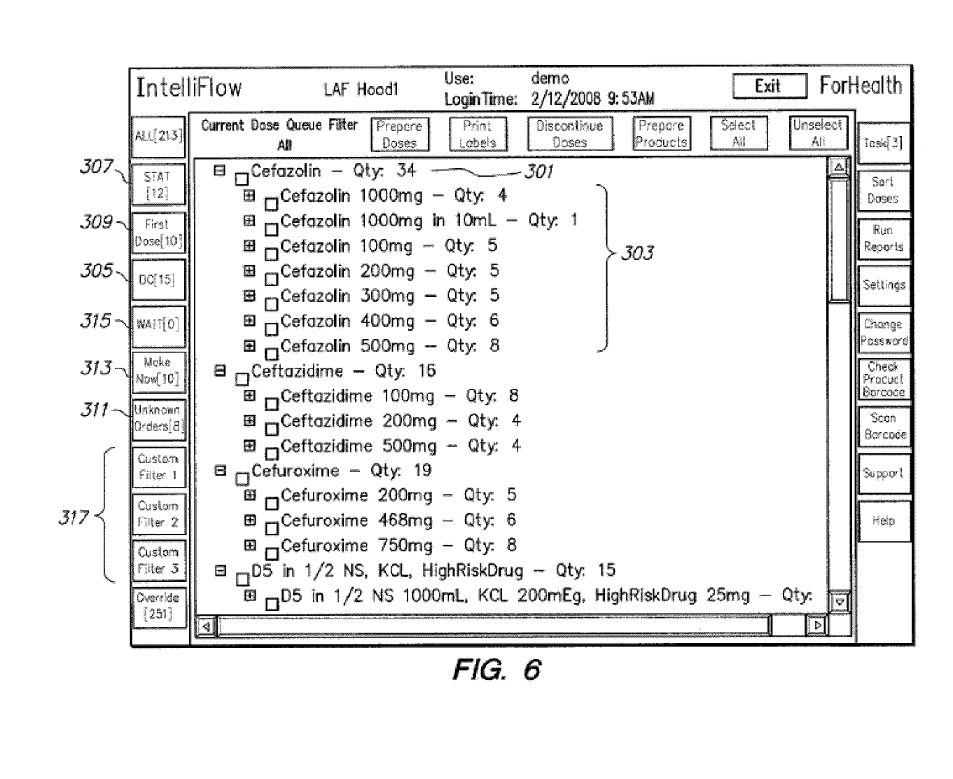

Referring briefly to FIG. 6, as previously mentioned, the dose orders are stored in the local database and are displayed on a display (touch screen) at one or more workstations. For example, each workstation can include a touch screen display that lists all received dose orders and can include identifying information or icons or other indicia that indicate which workstations are capable of fulfilling the dose order. An operator at a given workstation may thus view a running tally of received dose orders and may select the orders to be processed at his/her workstation. For example, the posted drug orders can be color coded or otherwise coded to indicate which workstation(s) is currently capable of fulfilling the order (assuming that all orders are displayed). Color coding may also be used to indicate a dose status (e.g., with STAT, “make now,” and “due soon” orders appearing in red, discontinued doses appearing in purple, first doses appearing in blue, and stock doses (i.e., doses not associated with a specific patient) appearing in green. As another example, there may be two workstations that are similarly equipped and one operator is principally responsible for filling certain medications unless the order queue for other medications becomes too large. An operator (technician) at any given workstation can thus look at the dose order queue and select certain dose orders to process and fulfill. Once the workstation operator selects the dose orders, as by highlighting them on the touch screen, the dose orders are assigned to this workstation and the selected dose orders can be eliminated from the dose order queue or otherwise indicated as being selected and not pending and available for selection by another operator at a different workstation.

In addition, if a workstation is off-line for maintenance or the like, the dose order processor will not indicate that this workstation is capable of fulfilling the order and will not assign dose orders to this workstation until it is back on-line and is fully operational.

The dose order queue may be sorted and displayed as a dose order record listing that includes the dose orders records in any number of different ways. For example, the dose orders can be sorted and displayed by drug type and can be further sorted by dosage amount as shown in FIG. 6. The total amount of dose orders for each drug can be displayed next to the drug name in a main banner 301 and then underneath the main banner, the various drug dosage amounts are listed along with the quantity of each that is currently needed (lines 303). For example, as shown in FIG. 6, the main banner shows that there are 34 orders for the drug Cefazolin and underneath, the various drug dosage amounts, such as Cefazolin 1000 mg; Cefazolin 100 mg; Cefazolin 200 mg, are listed along with the quantity that is needed for each. Other examples of interfaces for filtering, displaying, and/or otherwise managing a dose order record listing are presented below.

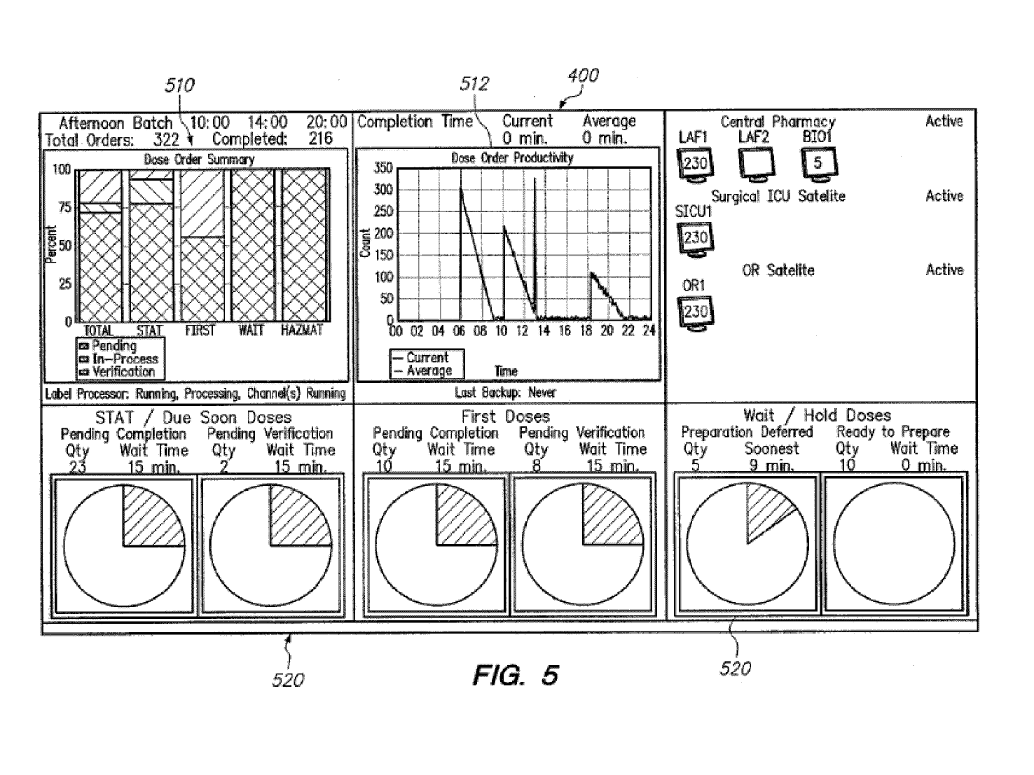

Each dose order record listing can be displayed in a different manner to indicate information that is intended and helpful to the operators at the one or more workstations that process and fulfill the dose orders. For example, on the left column of the screen that is shown in FIG. 6, a box 305 labeled “DC” stands for discontinued dose orders which are orders that have been discontinued for some various reason and therefore, do not need to be processed and fulfilled. The box can have an associated color, such as purple, that allows individual dose orders to be indicated as being discontinued and therefore, should not be selected for processing and fulfillment. For example, the Cefazolin 500 mg (Qty: 8) dose order line can be displayed in purple, thereby indicating that this dose order is discontinued and should not be processed. Also along the left column are other status indicators, such as “STAT” 307, “First Dose” 309, “Unknown Drug” 311, “Make Now” 313 and “Wait” 315. These indicators can dictate a preferred order of selecting and fulfilling the dose orders. For example, “First Dose” can indicate the highest priority dose orders which should be selected first before another dose order, including those dose orders that are labeled “STAT”. Meanwhile, the situation board (FIG. 5) provides an overview of the queue for all drug orders that are being handled.

In addition, other options available for selection by the operator at a station can be displayed, such as along the left column. For example, one or more filters 317 can be employed by the operator to filter the dose orders that are listed in the dose order queue. The filter 317 can be selected among standard ones, such as a filter that lists only those dose orders that can selected and fulfilled by the operator at a given workstation or the filter can be designed to only show only those dose orders that are classified as STAT orders and/or those that are classified as First Dose orders. Alternatively, the filter can be a custom filter that is created and defined by the workstation operator.

The dose order queue may also be displayed at a remote access terminal 314. Thus, the remote access terminal 314 may be operative to display the dose order queue according to the foregoing (e.g., where dose orders may be sorted and/or filtered for display). Furthermore, an administrator with proper administrative privileges may be operable to manage the dose orders contained in the dose order queue. As may be appreciated, this management may be facilitated within a terminal within the pharmacy 310 or by way of a remote access terminal 314.

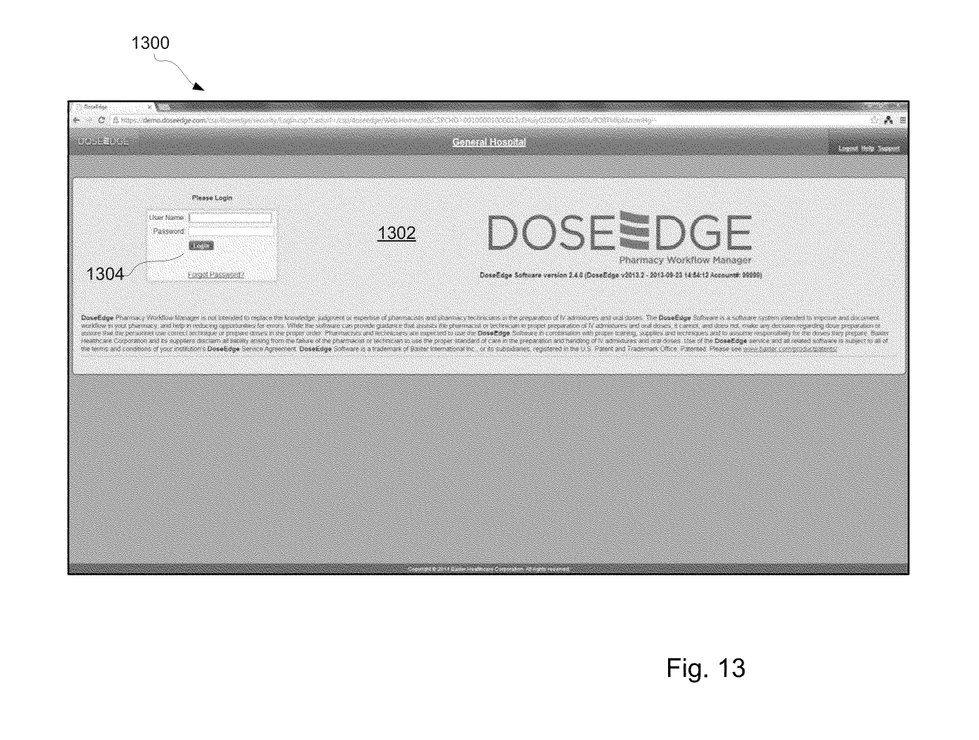

For instance, with reference to FIGS. 13-19, various user interface screens for an embodiment of a pharmacist workspace management tool 1300 are depicted. The management tool 1300 may be a web-based management tool that may be presented to a user in a web browser or the like. For instance, a user may navigate to a particular web address and be presented with a login screen 1302. The login screen 1302 may include an authentication field 1304 that may require, for example, a user name and password be entered by the user to facilitate confirmation of a user's authorization to utilize the management tool 1300 and/or access various functionality of the tool 1300. As may be appreciated, different user authorization levels may exist such that when a user logs in utilizing the authentication field 1304, various rights associated with the management tool 1300 may be allowed or blocked based upon the user credentials provided and the associated authorization level associated therewith.

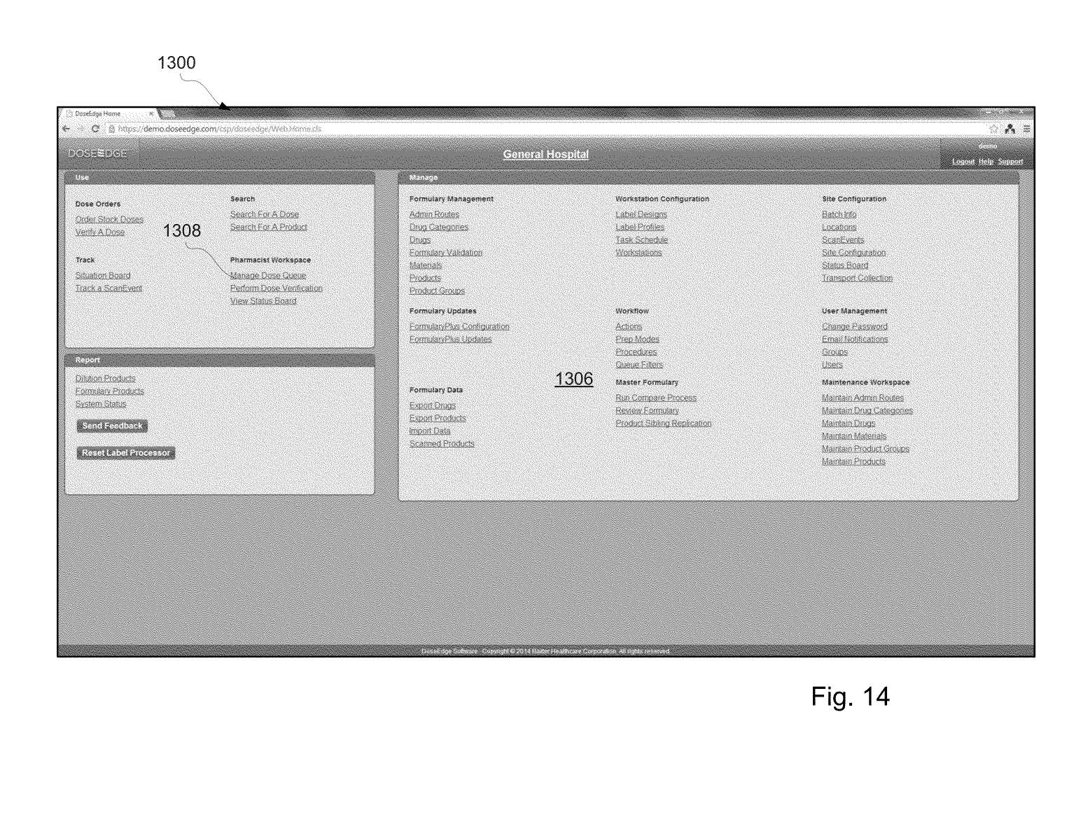

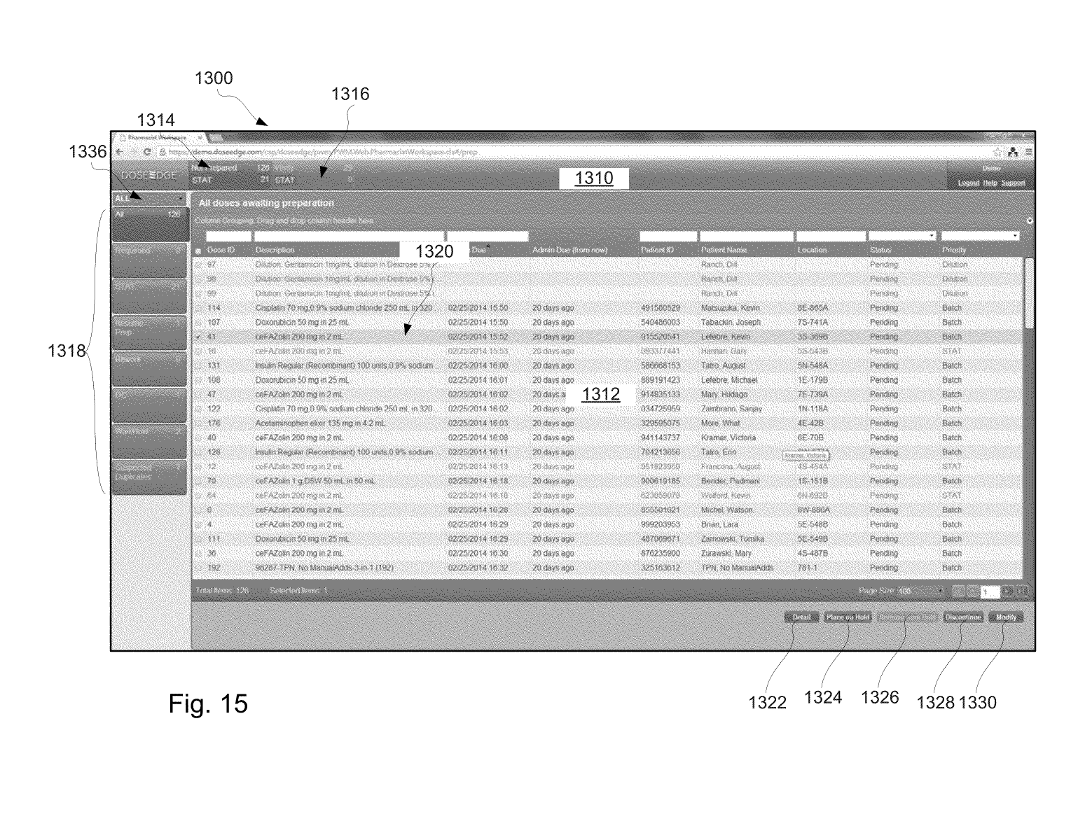

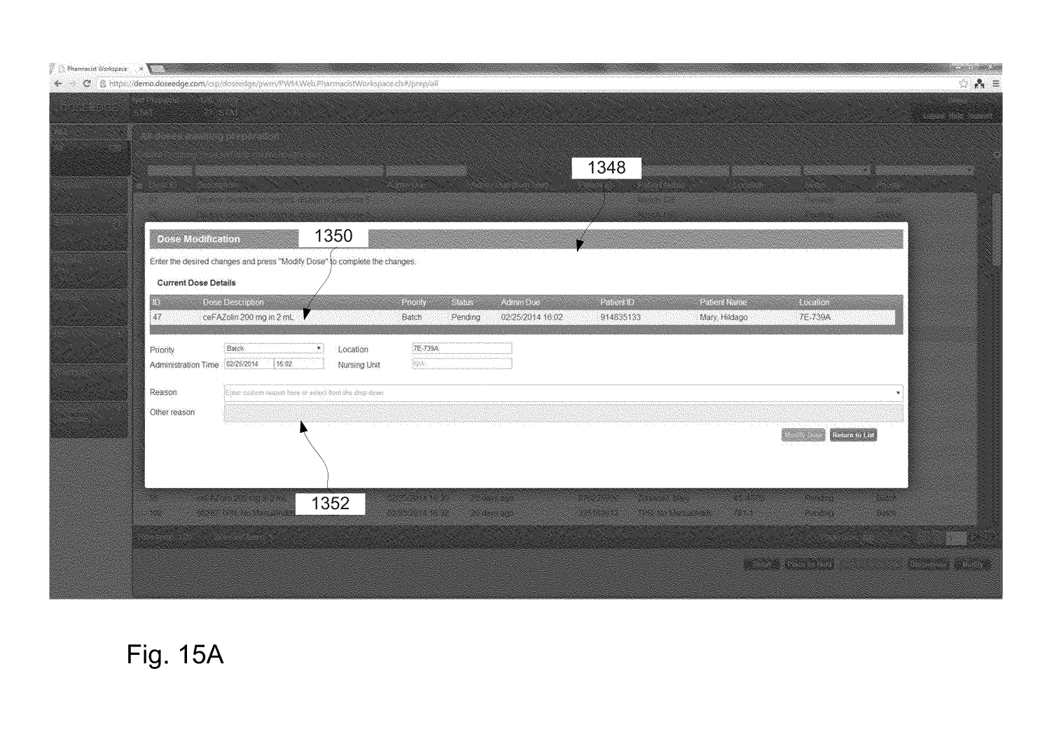

With further reference to FIG. 14, upon successfully authenticating the user, a navigation screen 1306 may be provided to the user. The navigation screen 1306 may include a plurality of links associated with various functions of the management tool 1300. For example, the navigation screen 1306 may facilitate access by a remote pharmacist use to verification screens used to review and verify doses that have been prepared in the pharmacy by a pharmacy technician as are described in greater detail below. The navigation screen 1306 may also include a link 1308 to a dose order management screen 1310. Selection of the link 1308 may result in the user being presented with the dose order management screen 1310 shown in FIG. 15.

The dose order management screen 1310 may include a dose order record listing 1312 that displays appropriate ones of the dose order records of the dose order queue stored in the local server 330. The dose order record listing 1312 may be arranged such that the individual dose order records are listed and divided by columns wherein each column corresponds with a different dose order record data field. As such, each dose order record data field column may be used to sort the dose order records in the dose order record listing 1312 (e.g., based on dose order metadata for each dose order record appearing in the dose order record listing). For example, the columns shown in FIG. 15 correspond to a dose identifier, does description, administration time, a relative time to administration, patient ID, patient name, patient location, a dose status, and a dose priority. In this regard, if desired the columns displayed in FIG. 15 may be used to sort the dose order record listing 1312 in ascending or descending order relative to the selected column.

The user may also utilize the dose order management screen 1310 to filter the display of the dose order record listing 1312. For example, the dose order management screen 1310 may include one or more tabs (e.g. 1314, 1316, etc.) that may be utilized to filter the dose order record listing 1312 according to status of the dose order records. For example, selection of tab 1314 by the user may filter the dose order records appearing in the dose order record listing 1312 such that dose order records with a status of “pending” may be displayed (i.e., including dose order records that have not yet been prepared). In this regard, selecting the tab 1314 may filter the dose order record listing 1312 such that dose order records but not yet been prepared may be shown. Selection of the tab 1316 may result in filtering of the dose order record listing 1312 such that dose order records are shown that have undergone preparation and are waiting verification by pharmacist. In this regard, the dose order records having a status indicating the dose orders are awaiting verification by a pharmacist may only be displayed in the dose order record listing 1312. It may be appreciated that additional tabs may be provided corresponding with different dose order statuses such as, for example, doses at initial review (i.e., doses not yet having been released for preparation), doses ready for preparation, doses awaiting in-line verification, verify doses awaiting sorting, doses awaiting rework, or any other appropriate status identifier that may be attributed to the dose order record.

The tabs 1314 or 1316 may also provide a user with a changeable graphical element that may allow for the user to be updated regarding various high-priority doses being added to the dose order record listing 1312. For example, if a STAT dose is populated into the dose order record listing 1312, a corresponding STAT dose indicator in the tab 1314 or 1316 may be updated to display the number of STAT doses currently in the dose order record listing 1312. Furthermore, the color indicator may be used to provide a quick reference to the user. For example, if a STAT dose is contained in the dose order record listing 1312, the STAT field in the tab 1314 or 1316 may be highlighted with a colored background (e.g., a red background that may be easily identifiable by the user even if not in close proximity with a display displaying the dose order management screen 1310).

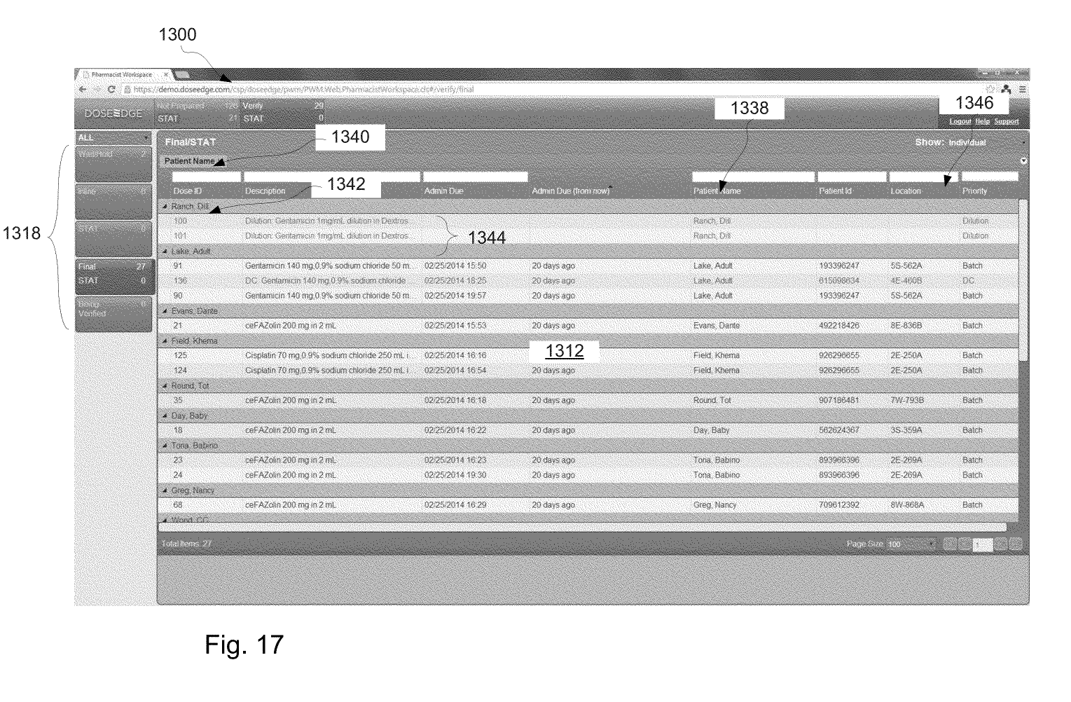

The dose order management screen 1310 may also include a plurality of secondary filters 1318 that may be utilized to further filter the dose order record listing 1312. For example shown in FIG. 15, the secondary filters may include a selection of all doses, requeued doses, STAT doses, resume preparation doses (e.g., doses is preparation have been interrupted), rework doses, discontinue doses, doses placed on weight and/or hold, and suspected duplicate doses. With reference to FIGS. 15 and 17, respectively, it may further be appreciated that the secondary filters 1318 provided may be based upon the tab 1314 or 1316 selected. For example, when the tab 1314 is selected for display of dose order records that have not yet been prepared, the secondary filters 1318 displayed may include those listed above including an all dose filter, a requeued dose filter, a STAT dose filter, a resume preparation dose filter, a rework dose filter, a discontinued dose filter, a wait/hold dose filter, and a suspected duplicate dose filter. However, upon selection of tab 1316 to display dose order records that have been prepared and are awaiting verification, the secondary filters 1318 may be modified to include a wait/hold filter, and in-line filter (e.g., to only display doses awaiting in-line verification), a STAT filter, a final verification filter, and a being verified filter. A queue filter 1336 may also be provided to allow for configurable filters to be generated and applied to the dose order record listing 1312 based on a configurable comparison of the dose order queue to predetermined dose order record data field values as will be described in greater detail below.

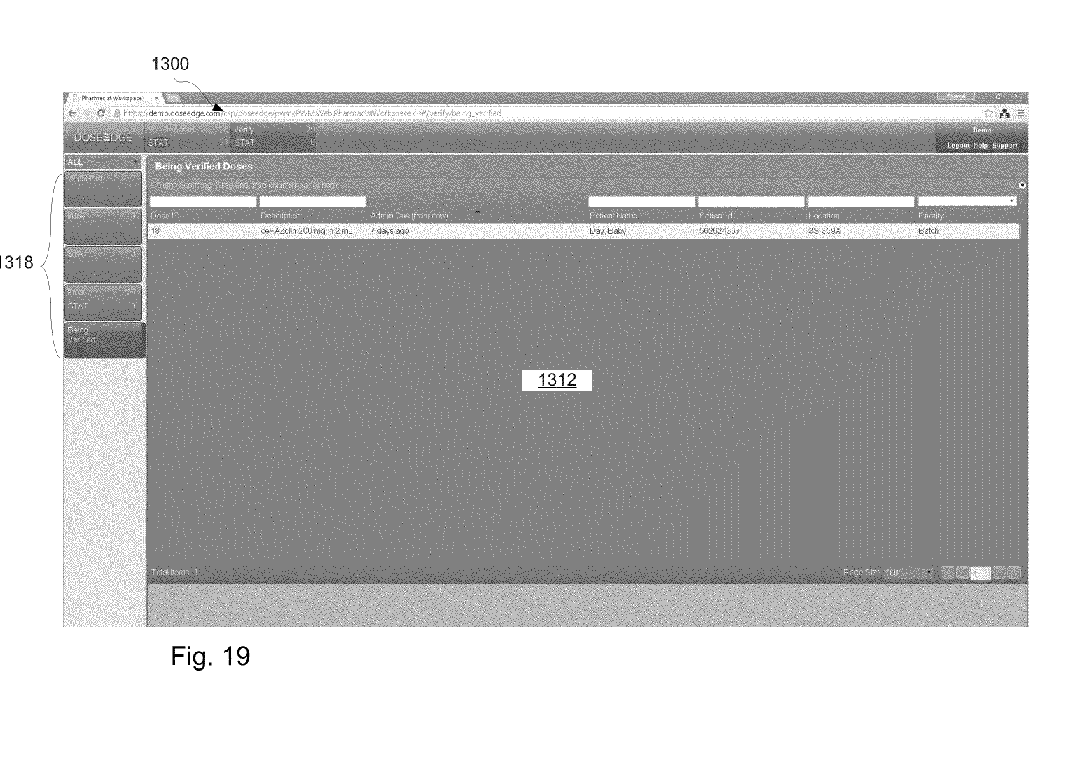

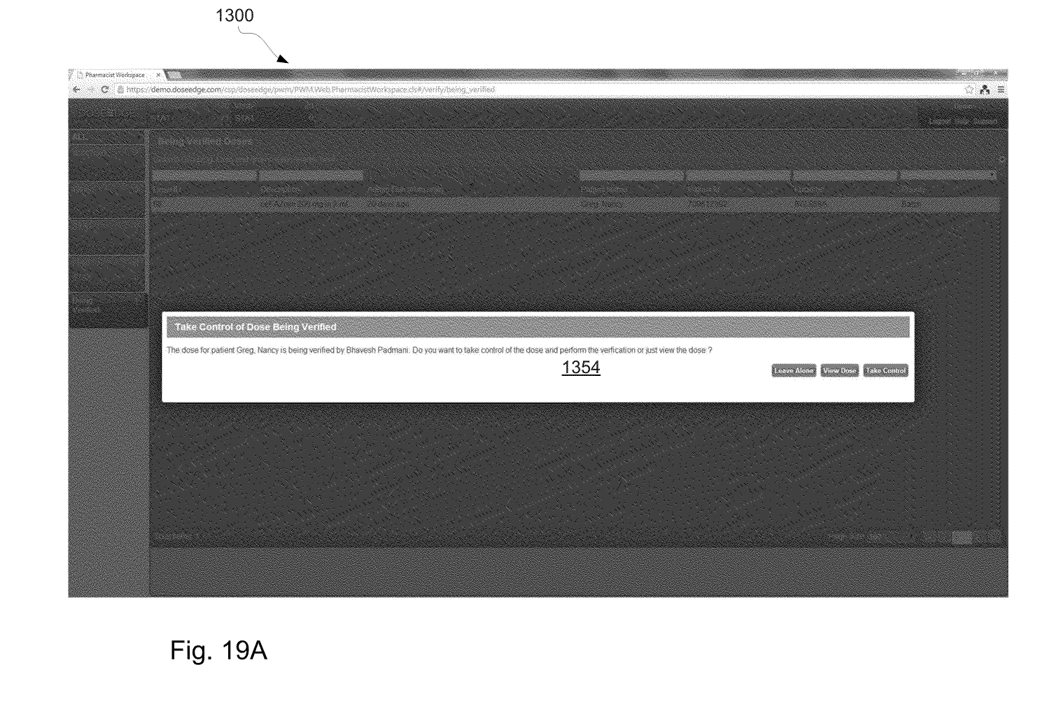

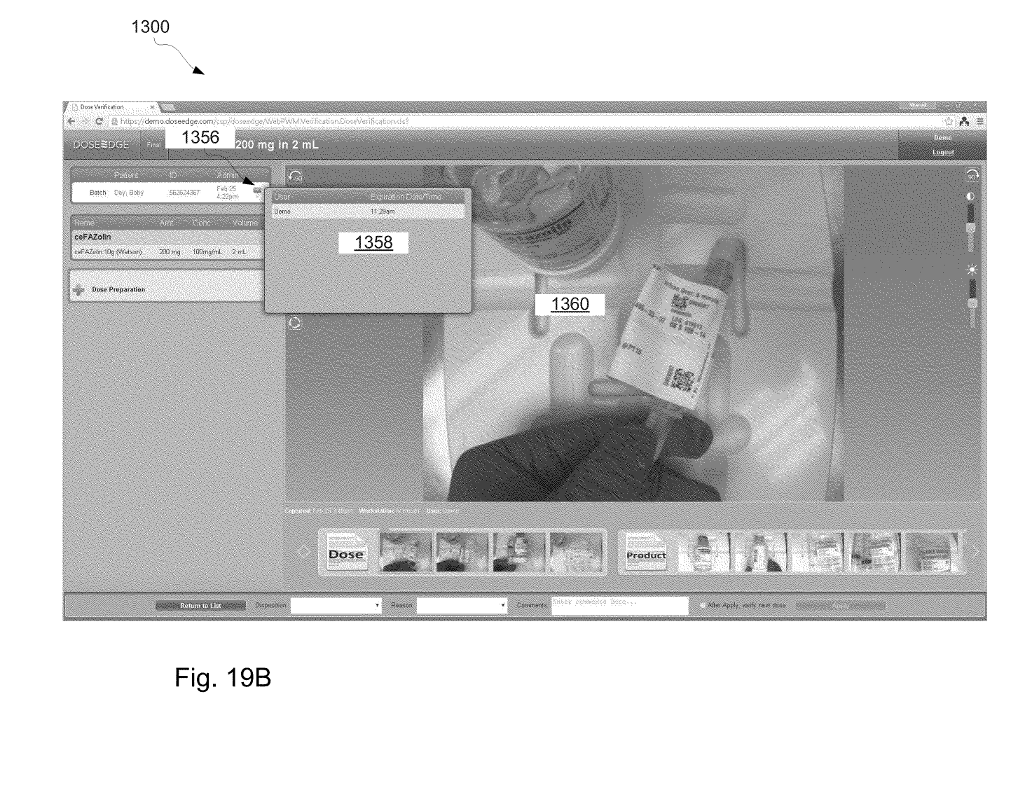

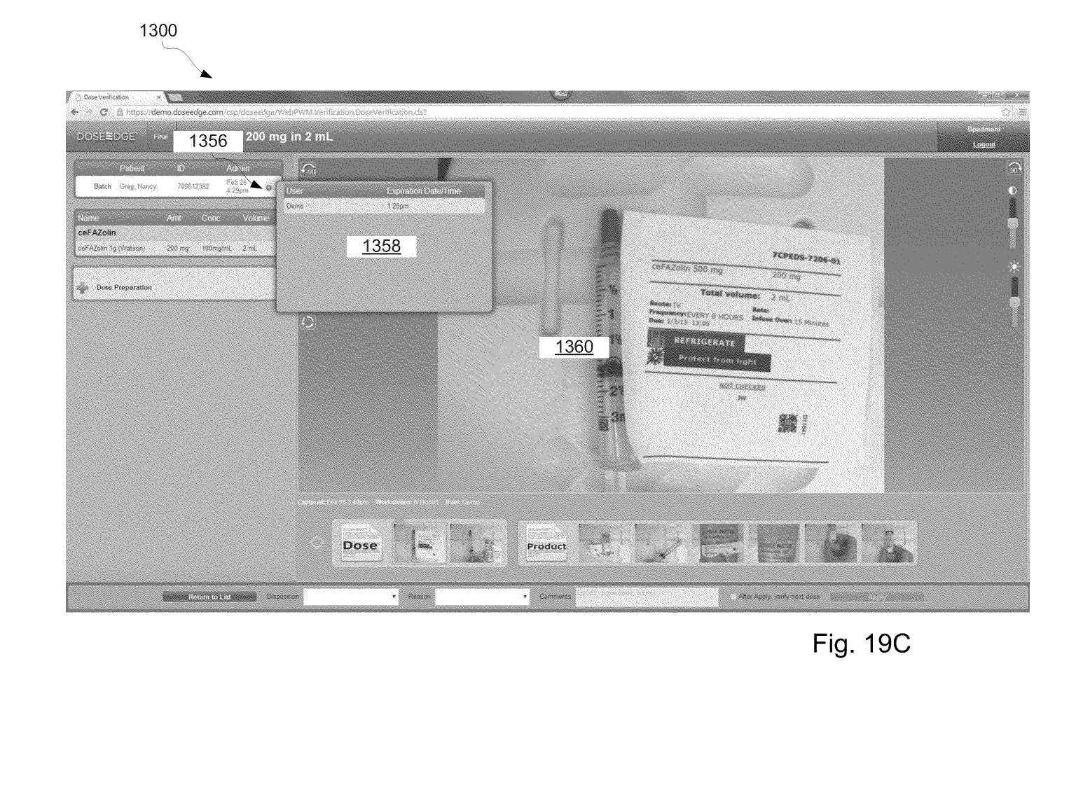

With further reference to FIG. 19, the dose order management tool 1300 may allow for a user to view and/or modify who has control over a dose order undergoing verification. For example, when a user selects a dose order record that has been prepared in order to verify the dose order, the dose order status may be changed to “at verification” or “claimed” to indicate that the dose is being verified by a user. However, under certain scenarios, the user may become distracted, be called away from the terminal at which verification is being performed, or otherwise be disposed such that the dose being verified remains in the claimed status without further action being taken with respect to the dose order. It may be beneficial to allow for another user to obtain control of the dose order record being verified such as for example, when a dose order associated with the verified dose order record is approaching administration time or if the dose order has a STAT priority or the like. Accordingly, with respect to FIG. 19, when tab 1316 is selected to display dose is awaiting verification, a secondary filter 1318 associated with doses being verified may be displayed to present a dose order record listing 1312 populated with dose order records with a claimed status. That is, upon selection of the being verified filter 1318, the dose order record listing 1312 may be populated with doses that are undergoing verification.

In turn, upon selection of a dose being verified by another user, a verification control dialog box 1354 may be displayed to the user as shown in FIG. 19A. The verification control dialog box 1354 may display to a user an indication of the other user who currently has control of (i.e., is verifying) the dose. The verification control dialog box 1354 may in turn include a number of controls (e.g., buttons) that provide for actions to be taken with respect to the dose being verified. For example, a user may select to leave the dose in the control of the other user by selection of the “leave alone” button. The user may also view details of the dose by selecting the “view dose” button. Finally the user may modify the control over the dose. In an embodiment, a control may be provided that allows a user to revoke the control over the dose from another user. Furthermore, as shown in FIG. 19A, a user may take control of the dose being verified by the other user by selecting the “take control” button.

Upon selection of the “take control” button, a user may obtain control over the verification of the dose from the other user. In turn, a dose verification screen 1360 for the user to control the dose may be shown as depicted in FIG. 19B. Specifically, a dose control indicator 1356 may provide an indication that indicates the user has taken control over the verification of the dose. Selection of the dose control indicator 1356 may provide details regarding the user and an expiration time corresponding to the time at which the user's control over the dose may cease in a dose control information window 1358. Correspondingly, a dose verification screen 1360 of the other user may be updated such that the dose control indicator 1356 of the other users modified to indicate the user no longer controls the verification of the dose. Furthermore, the dose control information window 1358 may be updated to display to the other user name user who is currently controlling the dose.

Returning to FIG. 15, it may be appreciated that a dose order record 1320 may be selected from the dose order record listing 1312. The selected dose order record 1320 may be signified by a checkbox provided in the dose order record listing 1312 and/or highlighting of the selected dose order record 1320 from among the other dose order record in the dose order record listing 1312. As may be appreciated, multiple dose order records may be highlighted has selected dose order records 1320 such that batch processing may be facilitated on selected ones of the dose order records 1320. Selection of the selected dose order record 1320 may result in a plurality of dose order operation buttons being enabled. For example, dose order operations buttons may include a detail button 1322, a place on hold button 1324, a remove from hold button 1326, a discontinue button 1328, and modify button 1330. Selection of a dose order operation button by a user may result in performance of a corresponding operation to the selected dose order 1320. For example, selection of the detailed button 1322 may result in the dose order management tool 1300 displaying in detail screen providing additional details regarding the selected dose order 1320. Selection of the place on hold button 1324 may result in the selected dose order 1320 being placed on hold status. Selection of the remove from hold button 1326 may result in a selected dose order record 1320 that is currently a hold status being removed from hold status. It may be appreciated from FIG. 15, the selected dose order 1320 and the particular embodiment shown is not on hold, therefore the place on hold button 1324 may be enabled while the remove from hold button 1326 may be disabled. In contrast, if a selected dose order 1320 was a dose order with an on hold status, the place on hold button 1324 may be disabled and the removed from hold button 1326 may be enabled. Selection of the discontinue button 1328 may result in the selected dose order 1320 being discontinued (i.e., the status of the selected dose order 1320 may be changed to a discontinued status). Selection of the modify button 1330 may result in display of a dose modification screen 1348 that allows for one or more portions of dose order metadata to be modified as shown in FIG. 15A.

Furthermore, the availability of a button for performing an operation relative to a dose order may be at least partially based on a level of authorization of a user. For instance, a user may be identified by way of a user name and password combination provided on the log in screen 1302. In turn, different respective users of the management tool 1300 may have different levels of authorization. In turn, the enablement of one or more of the buttons that provide management functionality relative to the dose orders appearing in the dose order record listing 1312. As such, for example, a user may have the ability to place a dose order on hold or remove a dose order from hold using the place on hold button 1324 or remove from hold button 1326, but not have sufficient authorization to modify a dose order using the modify button 1330. Further still, a user may have authorization to view a dose order record listing 1312 alone without any authorization to modify a dose in any regard.

With continued reference to FIG. 15A, the dose modification screen 1348 may be displayed upon selection of the modify button 1330 with respect to a selected dose order 1320. The dose modification screen 1348 may include the dose order record listing 1350 and a dose modification field 1352. The dose modification field 1352 may include one or more fields that allow for modification of one or more dose order record data fields associated with the selected dose order 1320. For example, the dose priority, dose location, administration time of the dose, nursing unit to which the patient for the dose belongs, or other parameters may be modified for the selected dose order record 1320. The dose modification field 1352 may also provide a field to accept a reason for the modification of the selected dose order record 1320. Providing a reason for modification of the dose may be required field that must be selected by user prior to allowing the dose order record to be modified. The reason may be selected from a drop-down field that may include a plurality of predefined reasons that may be selectable by a user. Additionally or alternatively, the user may enter a reason for the modification using free-form text entry in the other reason box. Furthermore, depending upon the authorization level of the user, the other reason provided by the user may be included for later selection and the reason drop-down list.

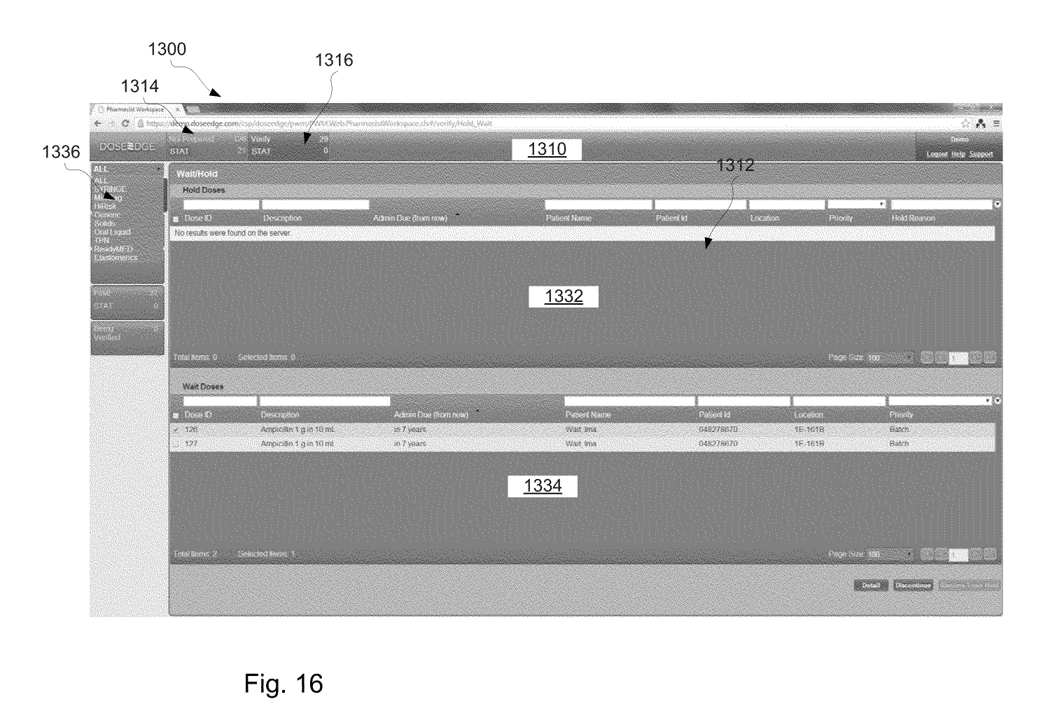

With further reference to FIG. 16, the dose order management screen 1310 is shown when the verify tab 1316 is selected. Upon selection of the verify 1316, doses that have been prepared and are waiting pharmacist verification may be displayed. Furthermore, FIG. 16 depicts the dose order management screen 1310 upon selection of a wait/hold secondary filter from the secondary filter list 1318. In this regard, the dose order record listing 1312 may be divided based upon a dose order record status of having a hold or wait status. Also shown in FIG. 16, a plurality of queue filters 1336 may also be provided. The queue filters 1336 may be configurable by a user and may allow for customization of filters to be provided. In this regard, the queue filters 1336 may include customizable parameter selection such that a filtered dose order record listing 1312 may be based upon any desired metadata for one or more dose order record data fields associated with the dose order records. That is, the queue filters 1336 may query any one or more of the dose order record data fields associated with each of the dose order records in return only those dose order records that match a query.

With further reference to FIG. 17, a further embodiment of the dose management screen 1310 is depicted. As shown in FIG. 17, the dose order record listing 1312 may be configurable to depict categorization of dose order records within the dose order record listing 1312. For example, user interface elements may allow for a column heading such as, for example, the patient name 1338 as shown in FIG. 17 to be dragged and dropped to a categorization bar 1340. Upon selection of the column heading 1338 for use in the categorization bar 1340, the corresponding column heading 1338 may appear in the categorization bar 1340. In turn, the dose order record listing 1312 may be configured to display dose order records according to category selected based upon the column heading 1338 selected. For example, shown in FIG. 17, the patient name column heading 1338 has been selected for use in the categorization bar 1340. In turn, the dose order record listing 1312 may be categorized according to patient name. Thus, the dose order record listing 1312 may include category headings 1342 within the dose order record listing 1312 such that associated dose order records 1344 corresponding to the category heading 1342 are presented. As may be appreciated, each category heading 1342 may be expanded or collapsed such that the associated dose order records 1344 for each category heading 1342 may be shown or hidden. It may be further appreciated the multiple category headings 1338 may be dragged and dropped to the categorization bar 1340. As such, the categorization within the dose order record listing 1312 may include a hierarchical listing such that a plurality of hierarchically displayed category headings 1342 may be provided in the dose order record listing 1312.

FIG. 17 also displays a column layout selection 1346 that allows for different column headings 1338 to be shown and/or hidden in the dose order record listing 1312. The column layout selection 1346 also allows for arrangement of the various column headings 1338. In this regard, the column layout selection 1346 may allow for user customization. In turn, the user may arrange the dose order record listing 1312 as desired including selection and/or arrangement of various column heads, categorization and/or filter results. In turn, once users authorized in the login screen 1302, the last used dose order record listing 1312 configuration or a default dose order record listing 1312 configuration any presented to the user.

Referring now to FIG. 5, a situation board 400 can be located at more than one location, such as at each workstation, as well as centrally within the pharmacy, and can be in the form of a browser-displayable “dashboard” that displays the overall status summary information about the current operations within the pharmacy (e.g., in the pharmacy IV room) through a conventional web-browser application such as Internet Explorer by Microsoft Corporation, Redmond, Wash. The situation board 400 can be displayed in the pharmacy on a large size, widescreen, flat panel display for high visibility and includes the count and percentage of doses awaiting preparation, in-process, or waiting verification. The situation board 400 thus lists all of the dose orders and permits operators at the various workstations to view all open orders and select orders as described below.

Dose order records stored in the local database can be ordered or arranged and displayed in the dose order queue and/or at the situation board in accordance with a rule base that operates on the database with one or more rules. The rules may be at least partially based on dose order metadata populating one or more dose order record data fields. For example, one rule can be to optimize fulfillment of the orders. Thus, like dose orders (e.g., dose orders with similar drug components as reflected in the dose order metadata) can be processed at the same workstation one after another and hence faster because there is less cross-contamination and medication changes (i.e., retrieval and storage). Thus, dose orders can be grouped by type or medication, such that dose records requiring the same medication or with no risk of cross-contamination can be processed in order by the same machine, or set of machines. In this regard, the rules are configured to sort the dose-orders by type or medication. Alternatively, dose order records can be prioritized by urgency (e.g., “First Doses” or “STAT”). For example, if a doctor urgently needs a specific medication, the data stream identifying the dose can include information indicating its urgency, and the dose order record can include such urgency information. Thus, the rule in this instance operates to re-sort an urgent order to near the front of the queue, or have that order identified (e.g., flagged) as urgent for immediate or expedited fulfillment. Through this or a similar mechanism, the next unfulfilled dose order retrieved at step 140 can be arranged in the queue to optimize throughput or to satisfy other rule-based priorities. Alternatively and as described above, urgent orders can simply be highlighted and/or labeled as such in the drug order queue presented at the workstation.

Rules may also be used to otherwise assist in management of the dose order records in the dose order queue. For example, the local server 330 may also include or be in operative communication with a dose logic engine (“DLE”). The DLE may be operative to evaluate dose order records based on one or more portions of dose metadata stored in corresponding dose order record data fields. In this regard, anyone or more the portions of dose order metadata as described above may be utilized in a rule implemented by the DLE. Furthermore, conditions for execution of rules executed by the DLE may be established such that the rule may be performed at one or more times on dose order records. For example, one or more rules may be executed on a dose order record by the DLE when the dose order record is initially populated in the dose order queue and/or upon a subsequent condition being satisfied such as a change in status of the dose order record or the like. In any regard, a rule executed by the DLE may include scrutinizing one or more portions of dose metadata in view of a rule. For example, Boolean searching or the like may be utilized to identify whether a rule is to be applied to the dose order record based on the occurrence of a selected parameter in the dose order metadata. Upon determining that a rule applies to a dose order record, an operation may be associated with the rule that is in turn executed on dose order records determined to be applicable to the rule. The operation may be utilized to manage and/or modify the dose order record identified by the rule. For example, the operations may include changing a status of the dose order, modifying metadata of the dose order, or other appropriate operation with respect order record or metadata associated with the dose order record. Two such examples of operations that may perform by the DLE include identifying duplicate orders and/or discontinued orders.

In a duplicate order detection rule, the DLE may be operative to review a first dose order record in view of other dose order records within the dose order queue to determine if the first dose order record corresponds to a potential duplicate dose order. In this regard, the DLE may evaluate the metadata regarding the first dose order record to determine if other ones of the dose order records within the dose order queue match the identified metadata regarding the dose order to a predetermined correspondence. The predetermined correspondence may be selectable by a user of the management tool 1300. It may be appreciated that the matching of the metadata between the dose order record being reviewed in the other dose order records in the queue may not necessarily need to be identical. For example, the rule may be written such that if selected ones of the metadata fields are identical between the first dose order record being reviewed and the other dose order records in the dose order queue, the dose order record being reviewed may be flagged is a potential duplicate order. Such a rule may be applied to the first dose order record when the record is initially populated the dose order queue.

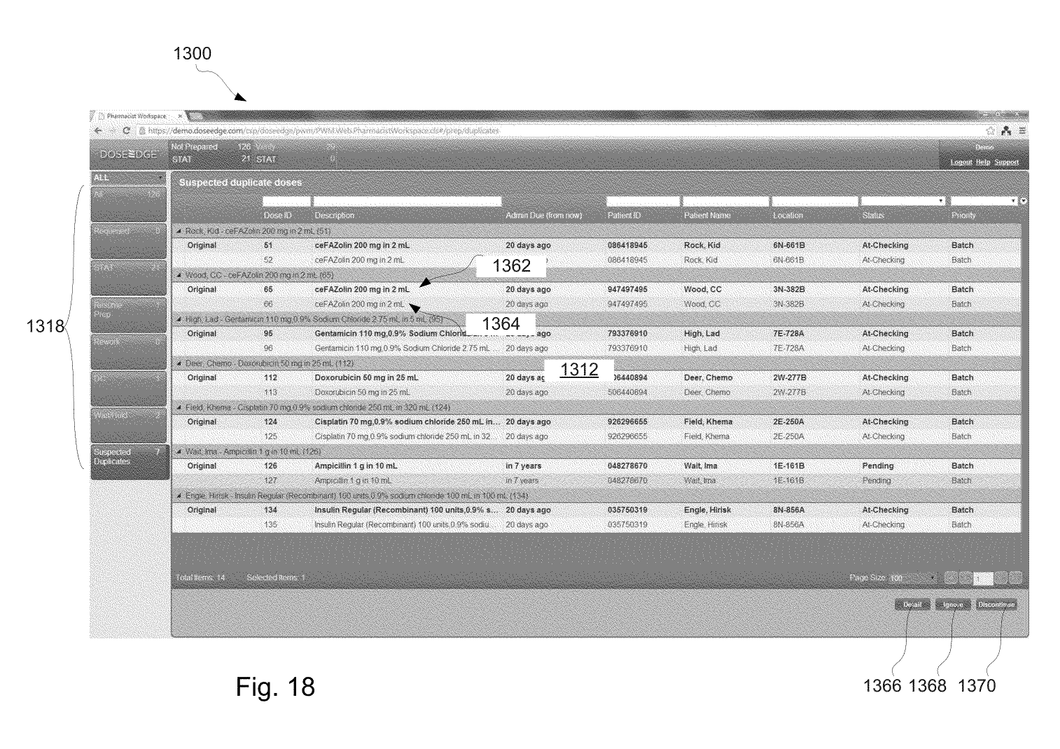

In this regard, with further reference to FIG. 18, may be appreciated that the dose order records that have been identified as a potential duplicate order may be sorted and presented to a user. In this regard, the dose order management screen 1310 may include a secondary filter for presenting suspect duplicates in the dose order record listing 1312. In this regard, the dose order record listing 1312 may be populated with suspected duplicates. In this regard, the dose order record listing 1312 may present a user in an original dose order record 1362 that is associated with one or more suspected duplicates 1364 based on exceeding a predetermined correspondence between the metadata of the suspected duplicates 1364 the original dose order record 1362.

Accordingly, upon selection of the suspected duplicate 1364, number of operation buttons may be enabled. For example, the user may select detail button 1366 to be presented with additional details regarding the suspected duplicate order 1364 and/or the original order 1362. In turn, the user may determine suspected duplicate 1364 may not in fact be a duplicate order, but rather be a valid order the should proceed preparation. In this regard, the user may select the ignore button 1368 to indicate that the suspected duplicate 1364 is not in fact a duplicate of the original order 1362. In contrast, should the user determine that the duplicate order 1364 is in fact duplicate of the original order 1362, the user may select the discontinue button 1370 to discontinue the duplicate order 1364 such that the duplicate order may be removed from the dose order queue. Upon selection of either the discontinue button 1370 or the ignore button 1368, the user may be present the dialog box that may require the user to identify the reason for the discontinuation or ignoring of the suspected duplicate status of the dose order.

Additionally, it may be recognized that the DLE may process incoming dose orders to determine if the order corresponds to a discontinuation of an order. That is, a common practice when processing dose orders is to indicate a discontinuation of a first order by subsequently sending a corresponding order to the first order at a later time with a discontinue status for the subsequently provided order. In prior approaches, the receipt of such a discontinued order may simply result in printing a label with the dose order details and a discontinuation status. This would in turn require a user to go through the printed dose order labels to locate the original dose order that was referenced in the discontinued dose order in order to replace the original dose order on a discontinued status. The DLE may be utilized to automate this process in the context of the dose order queue stored by the local server 330 by identifying receipt of a dose order in the dose order queue that contains a discontinued status and automatically matching the discontinued dose to one or more existing dose order records. Thus, receipt of a dose order with a discontinued status may trigger the DLE to perform a query of the dose order queue to identify corresponding ones of the dose orders in the dose order queue that exceed a predetermined correspondence to the discontinued dose order. For example, one or more overlapping or identical pieces of metadata between the discontinue dose order and the identified discontinued order in the dose order queue may be determined. The predetermined correspondence may be customizable by a user. In any regard, upon identification of a dose order record from the dose order queue that corresponds to a received discontinued dose order, the original dose order may automatically change the status of the one or more identified dose order records to a discontinued status.

The execution of a discontinued dose rule by the DLE may also at least partially be based upon the status of the one or more dose order records from the dose order queue that are identified as discontinued doses at the time the dose order records are identified. For example, in one example, the dose order for the dose order record identified as a discontinued dose may not yet have been prepared. In this regard, the DLE may simply change the status the dose order record to discontinued and remove the dose order record from the dose order queue such that the discontinued dose order record is not prepared. In contrast, the identified discontinued dose order record may have been prepared and verified and be in sort awaiting dispatch from the pharmacy. In this regard, the status of the dose order may be modified to discontinued and any resulting dose that was prepared for the dose order record may be changed from a dose to a product. That is, the dose order system may print a work in progress label or other identifier that allows the prepared dose to be moved to pharmacy stock for later use (e.g., to fulfill a later dose order received at the pharmacy). The modification of a dose to a produce may also occur in the case where a dose has been prepared and not yet verified. In this regard, the pharmacist that performs the verification may be presented with the status of the dose being discontinued.

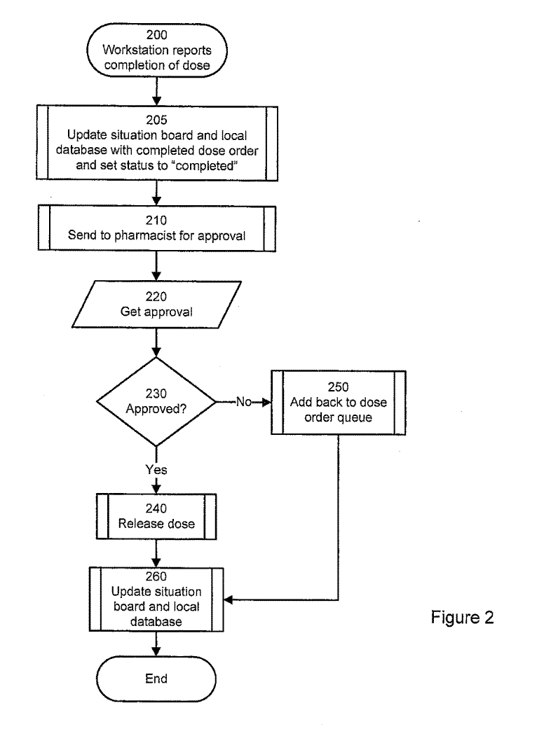

With returned reference to FIG. 2, at step 142, the drug order queue is generated and optionally one or more dose orders can be assigned to a particular workstation based on one or more rules that govern the distribution of dose orders to a particular workstation. The present invention can be configured so that the server receives, stores, and parses the incoming dose orders (e.g., by using the label processing module and other software) and generates the dose order queue that can then be posted at each workstation as well as at the situation board. The system can be designed so that the dose orders must be “pulled” from the dose order queue, in other words, an affirmative step can be required for the dose order to be assigned to a particular workstation. For example, as discussed above, an operator at a given workstation reviews the dose order queue and then selects those dose orders that he or she will fulfill, e.g., by using the touch screen display, at which time, these orders are effectively assigned to the workstation and are removed from the dose order queue.

In some instances the workstation is in the form of an automated device and therefore, the processor of the automated device has a selection module comprising code that causes a selection of those dose orders in the queue that can be fulfilled by the workstation. As discussed above, this selection can take into account a number of different rules including the number of pending dose orders at this workstation, the availability of different drugs, etc. The automated device communicates with the local server 330 and selects and pulls dose orders for filling.

However, even when the system is configured to operate in “pull” mode, the individual dose orders can be pre-assigned in the event that a dose order can only be fulfilled by a specific workstation, in which case the system recognizes this fact and identifies that this particular drug order is intended for delivery to that particular workstation. For example, if the dose order that is received and processed at step 141 is of a type that can only be fulfilled by a specific workstation (e.g., an automated chemotherapy workstation), the dose order will be identified as such on the dose order queue and the workstation type that is qualified for receiving and fulfilling the dose order can be notified. Similarly, the type of dose order can be identified as a manual fill dose order on the situation board and one or more manual workstations can be alerted or can simply include the dose order on its screen.

Alternatively, the dose orders can be “pushed” to the individual workstations in that the local server selects which workstation is best capable of handling the incoming dose order and then assigns the dose order to the workstation. The dose order is then sent to the workstation for fulfillment of the order.

Furthermore, as dose orders are received and parsed 110 or processed 140, the system can analyze the supplies necessary to fulfill the order. The list of required supplies can be compared to an inventory of supplies and their availability, optionally broken down by hospital, pharmacy location, or workstation. If there are insufficient supplies, additional supplies can be automatically ordered or the relocation of supplies from one workstation to another can be ordered such that at least one workstation will have the necessary supplies to fulfill the dose order.

In an embodiment, the rule based management of dose orders may facilitate automatically assigning a dose order based on the preparation mode for the dose order. For example, the dose order may be evaluated with respect to at least one portion of dose order metadata stored in dose order record data fields associated with the dose order record. This evaluation is performed upon population of the dose order the dose order queue. In turn, the evaluation may result in a preparation mode being assigned to an order. In turn, the user may be free from selecting the preparation mode associated with the dose order record, rather the preparation mode may be assigned automatically in response to the evaluation to the at least one portion of dose order metadata stored in the dose order record data fields. The preparation mode assigned to the dose order may be used, for example, to generate and/or select an appropriate preparation procedure for the dose order. Such a preparation procedure may in turn be presented to a user when preparing the dose. As the preparation mode may be automatically attributed to the dose order based on application of a rule to the dose order by the DLE, the user may not be required to select a preparation mode for the dose order. In turn, the dose order may be routed an appropriate workstation where the user may be presented with the preparation procedure at least partially based on the automatically assigned preparation mode that has been associated with the dose order record by the DLE. Furthermore, dose orders that have the same preparation mode may also be grouped together into a micro-batch in a queue view list.

Each dose order record initially has an unprocessed status and is operated upon by a particular workstation that is selected to convert the dose order into a particular drug dosage form in fulfillment of the order. A workstation can be adapted for a particular purpose, such as to include automated pill counters, automated syringe preparation, automated intravenous compounding stations, or be configured for manual preparation. In the case of manual preparation, workstations may be further adapted for particular manual preparation such as by type of workstation (e.g., bench, hood, box), by preparation mode (e.g., oral doses, syringe doses, bag doses, etc.). By examining the dose order record and/or applying dose logic rules, the fulfillment system can determine the appropriate workstation among available resources to which the dose order can be assigned at step 142, in view of the dosage order itself or its urgency, that is, its priority requirement for completion. The workstation assignment can further consider the supplies required to fulfill the dose order and the supplies available at each workstation. Also, at step 141, by examining the dose order record, the fulfillment system can determine whether a matching dosage form has previously been prepared and stored, based on the contents of an inventory record, and used to fulfill that order, as indicated at step 144. In the event that a match is located, the further steps of FIG. 1A do not need to be performed in order to provide the source of the order with the requested dosage form; however, to prevent inventory depletion, the order can be processed at a priority (that is, in a time frame) that is less urgent than indicated in the order itself since the preparation of a drug dosage form based on the dose order is for the purpose of restocking the inventory. Also, in the event of a match, a person can be directed to a particular location associated with the drug dosage form so as to retrieve it from inventory, and the retrieval can be registered so that the inventory record can be updated to reflect that event. This is described in the aforementioned U.S. application Ser. No. 11/844,135.

It would be understood by one of skilled in the art that the dose-preparation workstations can be located either centrally or in a distributed environment. Dose orders can be retrieved by or sent to workstations via standard data messaging techniques. A centralized environment allows for the pooling of resources. However a distributed environment allows fulfillment to be completed closer to the end user and can reduce some of the inefficiencies of centralization.

At step 150 each dose order record can be examined to determine if it is appropriate for an automated workstation, or an operation type of a selected workstation can be determined, for example, based on a flag, profile or other information associated with the workstation and interrogatable by the management module, such as workstation availability and its present set-up. For example, and automatically assigned preparation mode as described above may be utilized in the determination as to whether the dose order record may be suited for automated preparation had automated workstation. If the dose order record is appropriate for automated fulfillment, the order can be queued at an automated workstation and processed at step 170.

On the other hand, and in accordance with a salient aspect of the present invention, if the dose-order is one determined to be suited for manual preparation, then the process flow branches to block 160. At block 160, protocol information is retrieved. This is because, before the dose order record is dispatched to a manual workstation for action by the operator, additional information is provided to facilitate the manual fulfillment of the dose order at the selected workstation. This can be based on the determination that manual preparation is required and the assumption that providing additional information can improve safety, efficiency, and precision during fulfillment of the dose order. The management module can associate the additional information with the dose order record. For example, at step 160 the medication and form of dose (e.g., syringe, IV, oral dose etc.) specified by the dose order record can be examined so as to determine the protocol by which the dose of that medication should be prepared. The protocol can specify the steps (e.g., sanitization and documentation) that must be taken during preparation to comply with Food and Drug Administration regulations or any other governing procedures regarding the conduct of the pharmacy. Furthermore, the protocol associated with the dose order at steps 160 and 162, preferably is interactive in guiding the operator through the fulfillment process to achieve the same level of accuracy and dose safety which is typically associated with the automation. For example, the protocol can require the operator's input including logging of events at critical stages of the dose preparation process (e.g., requiring the operator to scan information related to the source drug containers).

The additional information (i.e., protocol) can be associated with the dose order record at step 162 for presentation to the operator. The association can be accomplished by attaching the protocol file to the dose order record, or otherwise communicating it electronically to the workstation selected for handling that dose order, or by printing a copy of the protocol to include with a printed order for the dose. In a paperless environment, the protocol is preferably displayed along with the display of the order or can appear as a hyperlink or call-up dialog box from within the order display at the workstation.

The workstation can include various tools and monitoring equipment to assist and perform quality control during the manual preparation of the dose order. Such tools and monitoring equipment can include barcode scanners, digital cameras, scales, hydrometers, spectrometers, and other tools that can be used to verify the properties of a substance. For example, a computer monitor at the workstation can prompt the operator to take certain measurements of the dose order being prepared and input the results of those measurements. Failure to input a measurement within an acceptable range can result in the system automatically rejecting the preparation. Furthermore, to prevent operator fraud, the system can prompt the operator to place the preparation on a scale, or within another instrument, that automates the measurement, thereby reducing the opportunity for the operator to intentionally or unintentionally deceive the system. In this regard, it should be appreciated that the protocol presented to the used at block 162 is preferably coded to capture the progress made toward dose fulfillment. Thus, steps taken in completing the protocol or recipe are preferably coupled with specific operator input such as photographing a drug vial, weighing a syringe, and the like, with the inputs being captured and included in a data record that can be forwarded to the pharmacist for review and approval. The data record can be a record storable in the Ensemble database that is used in a preferred embodiment of the invention.

As noted, one form of data capture during order preparation can be the capture of images of the medication source(s) used to prepare a particular dose. That is, a digital camera can record an image of each medication source, individually or together, that is used to prepare the dose. The image preferably displays the identification of the type of medication, its lot number, expiration date, and other quality control information that went into the final dose that is later submitted for pharmacist approval. The image(s) can be stored in the database or otherwise associated with the data record for the prepared inventory dose, and by accessing the dose order and the images associated with the prepared dose, from either a local or remove terminal/computer, a pharmacist or other authorized and qualified individual can verify that the correct medication sources were used to prepare the inventory dose.

Quality control can also include the recordation and logging of any technician or operator involved in the preparation of a dose order. The identity of the technician or operator can be recorded by fingerprint, key-card, username, password, or other known methods of identification. Additionally, quality control tasks can be assigned to specific workstations or operators, such as supervisors or quality control specialists. All of this information can be stored in the same data record as the medication dose, or in a different record that includes a link or information that permits association with the medication dose.

In one embodiment of the present invention, step 162 involves presenting the protocol to the operator in the form of a number of steps that must be performed in order to prepare the dose. As the operator performs each step or selected steps, verification that such step was performed must be entered by the operator or otherwise be confirmed by equipment that captures certain information presented by the operator. If during any step, a verification error arises and there is a question as to whether the step was properly performed, the dose order processing is prevented from continuing to the next step until the step is verified as being properly performed or until the dose order is flagged as being not completed due to an error. If this occurs, the operator can then receive the next dose order in the dose order queue for that particular workstation and start the dose preparation process for this new dose order. Thus, step 162 is akin to presenting the operator with a recipe except that several if not all steps that are performed have the operator interrogated to provide information that better ensures that each step was performed in accordance with the protocol. As discussed below, certain steps can be recorded by using one or more cameras or other equipment and thus, a record is compiled and saved for each dose order in case there is every any question as to the integrity of the dose order and whether an error was made in processing the dose order.

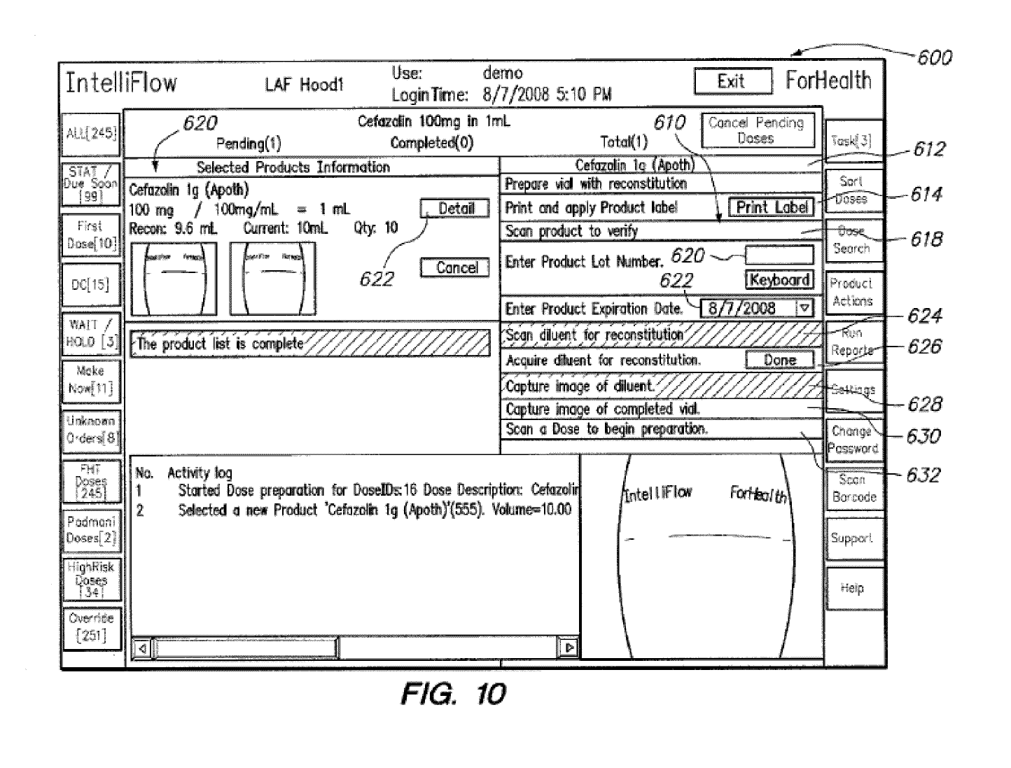

Referring briefly to FIG. 10, one exemplary screen 600 is illustrated that lists a number of steps generally indicated at 610 that are required to be performed to successfully prepare a medication product that is used to prepare a dose that is part of a dose order. On the left side of the screen, the drug to be prepared is clearly identified at 620, in this case Cefazolin 1 g (Apoth). This screen is an interactive screen in that the user can simply highlight different areas either to receive more information or to enter information. For example, there is a Detail button 622 near the drug identification and if additional information is needed concerning this particular drug order, the user can simply highlight this particular button (as by “clicking” the box).

On the right side of the screen are processing steps 610 that must be undertaken in order to prepare the requested dose. For example, a banner 612 indicates again the drug being produced is Cefazolin 1 g (Apoth) and below this banner there are a number of steps 610 that must be performed in order to produce the correct dose (drug product). The illustrated screen shows a first step 614 of printing and applying a product label. The label is printed by simply pressing the button 616 that is labeled “Print Label”. As soon as the label is printed, the user is prompted to move on to the next step 618 which is a step of scanning the product to verify that the proper product is present at the workstation. Conventionally scanning equipment can be used to scan (e.g., a barcode) the product and then the user is prompted to enter the Product Lot Number in a box 620 that is provided and the user then enters the Product Expiration Date in another box 622. All this inputted information is used to confirm that the correct product (drug) is present and is being used in the preparation of the Cefazolin 1 g dose.

In another aspect of the present invention, other identifying information can be used to assist in determining that the correct drug is present at the workstation and is suitable for use in fulfilling a pending drug order. More specifically, the Drug Listing Act of 1972 requires registered drug establishments to provide the Food and Drug Administration (FDA) with a current list of all drugs manufactured, prepared, propagated, compounded, or processed by it for commercial distribution. The National Drug Code (NDC) is a universal product identifier used in the United States for drugs intended for human use. The FDA inputs the full NDC number and the information submitted as part of the listing process into a database known as the Drug Registration and Listing System (DRLS). The information submitted as part of the listing process, the NDC number, DRLS, and the NDC Directory are used in the implementation and enforcement of the Act.

The National Drug Code is a unique 10-digit, 3-segment number assigned to each medication listed under Section 510 of the Food, Drug, and Cosmetic Act. The number identifies the labeler or vendor, product, and trade package size. The first segment (the labeler code) is assigned by the Food and Drug Administration. A labeler is any firm that manufactures, repacks, or distributes a drug product. The second segment (the product code) identifies a specific strength, dosage form, and formulation of a particular firm. The third segment (the package code) identifies package sizes.

The official format of the NDC code is a 10-digit number that can be presented in one of three formats:
1) 4-4-2=1234-5678-90
2) 5-4-1=12345-6789-0
3) 5-3-2=12345-678-90

When presented electronically, the NDC number is presented as a 10-digit, unformatted number (such as in a bar code). The 10-digit, unformatted number can be accessed and used as part of an automated drug preparation system in that this number can be used to locate drugs that are stored at a storage location. However, when presented in print, the NDC number is presented as a 10-digit formatted number as shown above. Consequently, a drug label on the drug container will typically have the formatted NDC number.

Recently, the format of the NDC has been revised and changed so that it includes 11 digits as opposed to 10 digits. The new 11 digit NDC number has a 5-4-2 format. More specifically, database vendors, CMS (Centers for Medicare & Medicaid Services), and recently, the FDA are now using an 11-digit unformatted number that is intended to remove ambiguity between the three formats that were previously used for 10 digit NDC numbers. Since many drug preparation systems, including the present one, purchase formulary data from a vendor (e.g., Multum), the 11 digit unformatted form of the NDC data is automatically provided in the formulary when the formulary is loaded into the drug preparation system. Conversion from the 10 digit code to the 11 digit code results from the proper placement of a zero. More particularly, the 11-digit code is created by adding a leading zero (0) to the field (in the 10 digit code) that has too few digits. The table below shows the transformation.

| 10-digit | | 10-digit | 11-digit | 11-digit |
|---|---|---|---|---|
| formatted | Format | unformatted | formatted | unformatted |
| 1234-5678-90 | 4-4-2 | 1234567890 | 01234-5678-90 | 01234567890 |
| 12345-678-90 | 5-3-2 | 1234567890 | 12345-0678-90 | 12345067890 |
| 12345-6789-0 | 5-4-1 | 1234567890 | 12345-6789-00 | 12345678900 |

The conversion between the 10 digit unformatted NDC number to the corresponding 11 digit unformatted NDC number or vice versa is complicated and there is no reliable conversion method since there is no way in positively telling where to add a zero (0) or which zero (0) is to be either deleted. The only reliable manner to transform between a 10 digit format and an 11 digit format is to start with the 10 digit formatted number.

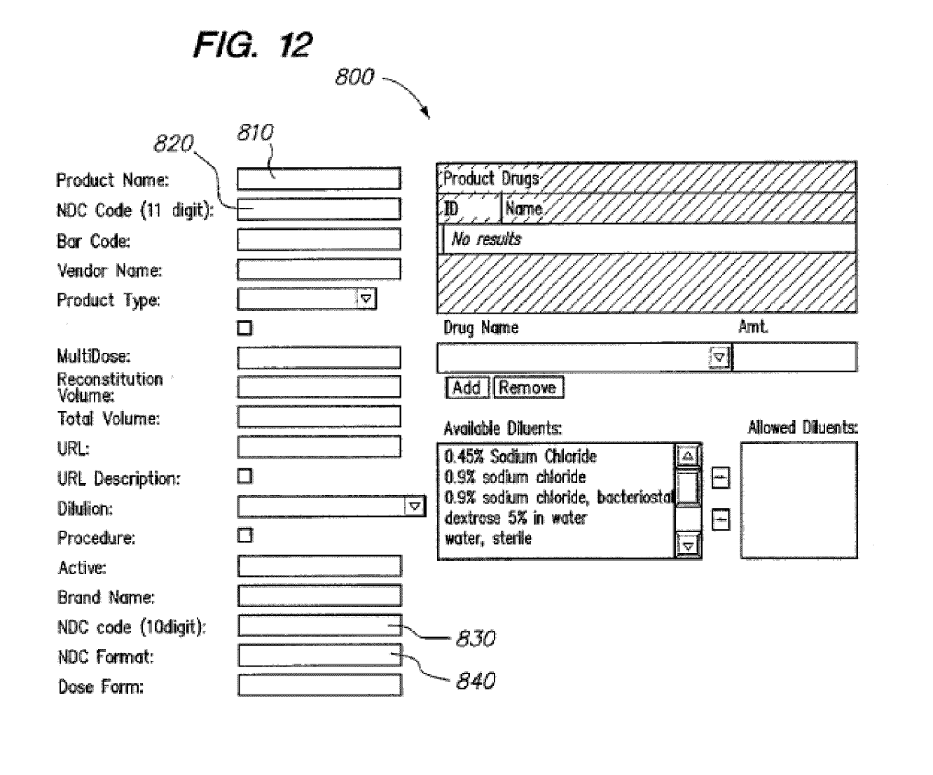

In accordance with the present invention and as shown in FIG. 12, an interface of the present system can include areas where NDC information is inputted. For example, a product information screen 800 is shown in FIG. 12 and includes a number of input fields (input boxes with or without pull down type menus) where a user can input certain product information. It will also be appreciated that some of this information can be inputted using a reader devices, such as a barcode reader, etc. Part of the product input information includes NDC related information. For example, in FIG. 12, the product information screen 800 includes a product name field 810; an NDC code field 820 that contains the unformatted 11 digit NDC number; an NDC code field 830 that contains the unformatted 10 digit NDC code, and an NDC format field 840 that contains the 10-digit format (i.e., 4-4-2, 5-4-1, or 5-3-2). By storing the 10 digit unformatted NDC code, conversion to the 11 digit format is possible. In addition, by storing, the NDC format at field 840, the integrity of the conversion process is ensured.

By inputting and storing the above information, the present system is capable of handling requests and requirements from entities, such as CMS, that require 11 digit NDC codes. In addition, by storing the 10 digit NDC code, the present system and the formulary stored therein, can process and communicate with third party systems that require the 10 digit NDC codes. As new CSP/drugs are added to the formulary (e.g., by loading formulary updates), both the 10 digit and 11 digit NDC codes are updated.

In accordance with the present invention and as previously mentioned, the present system includes means, such as readers and the like, which allow a particular drug to be identified at step 618 and compared to a database to ensure that the identified drug is the drug which is being requested is the same drug which has been identified at a particular location (station) of the present system. Since the NDC includes product code information, such as the specific strength, dosage form and formulation, it can be used in drug identification step 618 of the present system. It will also be appreciated that the NDC number can provide a means for redundantly confirming the identification of the drug being used at the work station to prepare the requested drug order. In other words, other identifying information that is printed or otherwise present on the drug product can be read and then the NDC number can be read and the two compared as part of an integrity check to ensure that the correct drug product is present at the workstation.

The next step 624 involves scanning the diluent that is used in the reconstitution process. Once again, conventional scanning or imaging techniques can be used to identify and confirm whether the correct diluent is being used in the reconstitution process. The step 626 involves acquiring the diluent for the reconstitution and then confirming its proper identity and the user can indicate that the step has been completed by pressing the button labeled “Done”. The next step 628 can involve capturing the image of the diluent using conventionally techniques (e.g., a camera) and additional steps that can be performed are capturing the image of the completed vial 630 and scanning a dose to begin preparation of the individual dose 632. All of the information that is gathered in each of the steps is stored in the local database, preferably in the same record as or in association with the particular drug order being filled.

At any point, if a task performed in one of the steps is not verified as being correct, the operator is prevented from going onto the next step and the dose is not prepared.

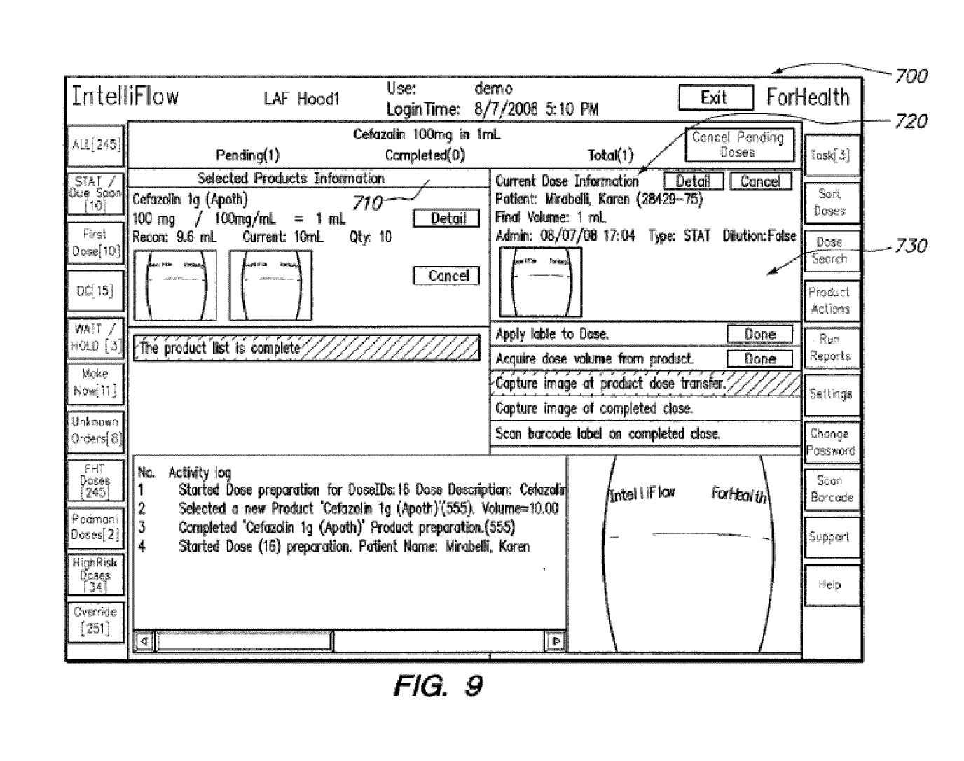

Also, with brief reference to FIG. 9, a sample screen 700 shows exemplary steps that are displayed to the operator to assist the operator in preparing a specific dose of medication. On the left side of the screen, a “Selected Products Information” section 710 is provided and lists the drug product that is being prepared. In this example, the drug product is Cefazolin 1 g (Apoth). On the right side of the screen is information 720 that relates to the current dose that is being prepared for a specific patient. For example, the patient's name (e.g., Karen Mirabelli) is clearly identified along with any identifying patient information (a patient number). The dose information also includes a final volume of the dose (e.g., 1 ml) and administration information is provided, such as a date and time (e.g., Aug. 7, 2008 17:04) when the dose is to be administered. The type of dose (e.g., STAT) can also be listed to alert the operator to any special processing information (e.g., the dose should be processed in an urgent manner).

The screen of FIG. 9 lists a number of steps 730 that are to be performed by the user to prepare the dose and fulfill the dose order. For example, one step may be the step of applying a label to the dose and once this task is performed, the user can indicate so by pressing a button that is labeled “Done”. Another step can be to acquire the dose volume from the product and once this task is performed, the user can indicate so by pressing a button that is labeled “Done”. Other steps that are to be performed and verified are capturing the image of the product dose transfer; capturing the image of the completed dose; and scanning the barcode label on the completed dose. Each of these steps must be verified as being properly completed before the user can continue with the other steps of the dose preparation process.

The NDC information also contains formulary information and this can be used at the workstation as the drug is being prepared in accordance with the steps shown and described with reference to FIG. 9. In particular, this information can be used as part of an integrity check (drug verification process) to ensure that the drug is being prepared properly.

Referring again to FIG. 1A, the steps presented to an operator at a workstation generally include a number of steps. At step 163, a counter is started to make sure all N steps are performed. The value (i) is equated to 1 at step 163 and in step 164, the operator is stepped through the recipe (protocol) where the recipe includes steps 1 to N. In step 165, the operator is presented with a step to perform (namely, step i). At step 166, the operator must present some type of feedback (e.g., capture an image or scan a barcode) or confirm that the action requested at block 165 has been performed. If the feedback confirms that the step 165 was properly performed, then at block 168, a comparison is made between the value of i and N and if i=N, then the order has been filled and the flow proceeds to step 180, as described below. On the other hand, if i does not equal N, the process flow proceeds to block 167, where the value of i is incremented (e.g., by 1 as shown (i=i+1), and then the process flow loops back to step 164 so that the operator can be presented with the next step of the recipe. The steps 164 to 168 are performed until i=N which indicates that all steps have been completed.

As mentioned above, if it is determined at step 150 that the dose order record is suitable for automated handling, it will be queued at an appropriate automated workstation. Queuing the dose order record at a workstation presents a further opportunity to optimize the distribution of orders within the pharmacy. For example, it may not be feasible to determine at step 140 an optimal organization of dose order records to ensure that dose order records requiring similar medications are queued at the same workstation. Thus, at step 170, a particular dose order can be queued at an automated workstation that is known to be processing the same medication, or to any workstation at which a dose order involving the same medication was just queued (e.g., a workstation to which the dose order and protocol are provided at block 160. Re-ordering and queuing of dose orders can be very flexible if the urgency of the dose order is very low. For example, the dose orders can be queued in a less than optimal order with respect to time, but more efficient with respect to medication changes and cleanings to prevent cross-contamination. Optionally, the current workload and/or work distribution of dose orders to workstations can be tracked or monitored and presented to a user (e.g., presented on a centralized display) for management and performance monitoring.

Moreover, various quality assurance activities can be assigned to workstations. These activities can include mandatory cleaning, training sessions, or inventory procedures. They can be scheduled at a workstation based on necessity (e.g., if the workstation is determined to be “dirty”), passage of time (e.g., protocol can call for cleaning or training every two hours or two days), or by need (e.g., monitoring procedures determine that certain equipment is “dirty” or that a particular operator is making mistakes and requires additional training) As used herein, “dirty” refers to a station being in a queue for a cleaning.

Once the workstation fulfills the dose order, the status of the dose order record can be changed to indicate that it has been processed at step 180. The status change can be received by the fulfillment system as an acknowledgement that the drug dosage form has been prepared, or as a “processed-order” status, and this can further result in an update to the dose order record, the inventory record, or both concerning any drug dosage forms that have been prepared but not yet delivered. Additionally, data concerning the assignment of the dose order to the selected workstation and the completion of the dose order can be logged in the database. Logging information concerning which workstation processed the dose order into the database (e.g., an Ensemble database), as indicated at step 190, enables complete tracking of both the dose-order processing steps and tracking of the prepared dose itself from its entry as data into the pharmacy system to its delivery to the patient. Accordingly, at step 190, the information can be logged into the Ensemble local database and the situation board updated to show completion of the drug order. The situation board thus provides an updated tally on current drug orders being processed and historical information on processed drug orders, thereby affording the pharmacy and workstation operators hands-on access to performance data and other relevant information concerning the dose orders that are being requested for fulfillment.

In this regard, a plurality of dose orders may be aggregated to define a transport collection. For example, a transport collection may be identified for a specific final destination within a facility for more efficient transport of doses to the final destination in the facility. As such, the final destination may, but is not required to, correspond to a physical location within a hospital or other care facility. In this regard, verified doses may be scanned to identify the dose order for the dose. Subsequently, a transport collection (e.g., a tag or other machine readable identifier) may be scanned to associate the dose order with the transport collection. In this regard, when the transport collection undergoes a scan event (e.g., corresponding to a change in location of transport collection), all dose order records that are associated with transport collection may be updated without requiring each dose order record and transport collection to be scanned.

The transport collections may be associated with the final destination. In this regard, prior to association of a dose order with transport collection, one or more portions of dose metadata may be scrutinized determine the appropriateness of the dose order being added to the transport collection. For example, a transport collection may be established that is to be distributed to a predetermined location within a hospital. As an example, a transport collection may be defined corresponding to a fourth floor nursing station. In this regard, if the dose order record has dose metadata associated with a corresponding dose order record data field that indicates the dose order is not to be transported to the fourth floor nursing station, a transport collection rule may prevent association of the dose order with the transport collection rule. In this regard, the rule may scrutinize dose order metadata associated with a dose order to determine the appropriateness of the dose order records in relation to the transport collection. As such, a dose order record that includes dose order metadata not associated with acceptable metadata for the dose order record may be disallowed from being associated with the transport collection. The metadata scrutinized by the transport collection rule may be any appropriate portion of metadata and not simply limited to a location provided in the dose order data. For example, it may be recognized that a location may be unacceptable for handle hazardous doses such as chemotherapy doses or the like. In this regard, any portion of dose order metadata regarding the dose order (e.g., drug identifiers like) may be utilized to define transport collection rules.

The foregoing discussion details the process by which a data stream containing medication dose order information enters the pharmacy and is processed by the local server 330 (which includes a label processing module, a database such as the Ensemble database mentioned above, and web services) and filled so as to produce the requested pharmaceutical dose. The fulfillment system is further capable of responding to any status inquiries concerning a given dose order with order status (e.g., “unprocessed,” “in-progress at {selected workstation},” “processed” and the like) and optionally a location (e.g., in bin A, on cart B, in pediatric ward, etc.). The fulfillment system is also capable of monitoring and tracking the prepared dose through to its delivery with additional status information (e.g., dispensation to patient {X}s), as discussed next with reference to FIG. 2.

Referring now to FIG. 2, a process flow is illustrated that commences when a workstation identifies a particular dose as having been completed, as indicated at terminator 200. The local database is updated with completion information at step 205, and this provides status information that can be referenced by persons outside of the pharmacy in response to a status inquiry and by the system in managing the distribution of subsequent dose orders. The identification preferably associates a unique identifier with the dose. The database record associated with the identified dose can be marked as completed. Alternatively, various other subsystems can be notified of the completion of the dose. For example, a storage subsystem that tracks medication that is “on-hand” can be updated with the prepared dose's record. Additionally, a delivery subsystem can be notified that the prepared dose is completed and ready for delivery to its destination. At a later time, for instance, according to a schedule, the information in the local database can be uploaded to a central server 390 that can be configured to communicate with the respective local databases of multiple pharmacy systems.

At step 210, the completed dose order is sent to a pharmacist for approval to allow the dose order to be released if it is verified. At step 220, the pharmacist is presented with the information necessary to decide whether the dose order should be approved. If the pharmacist is on-site, the pharmacist can visually inspect the dose order and if the dose order was manually prepared, the pharmacist can interview the clerk who filled the dose order in order to verify that protocol was properly followed. If the drug order was prepared by an automated system, the pharmacist can review the associated records of the dose order that were generated by the automated drug preparation system during the processing of the dose order.

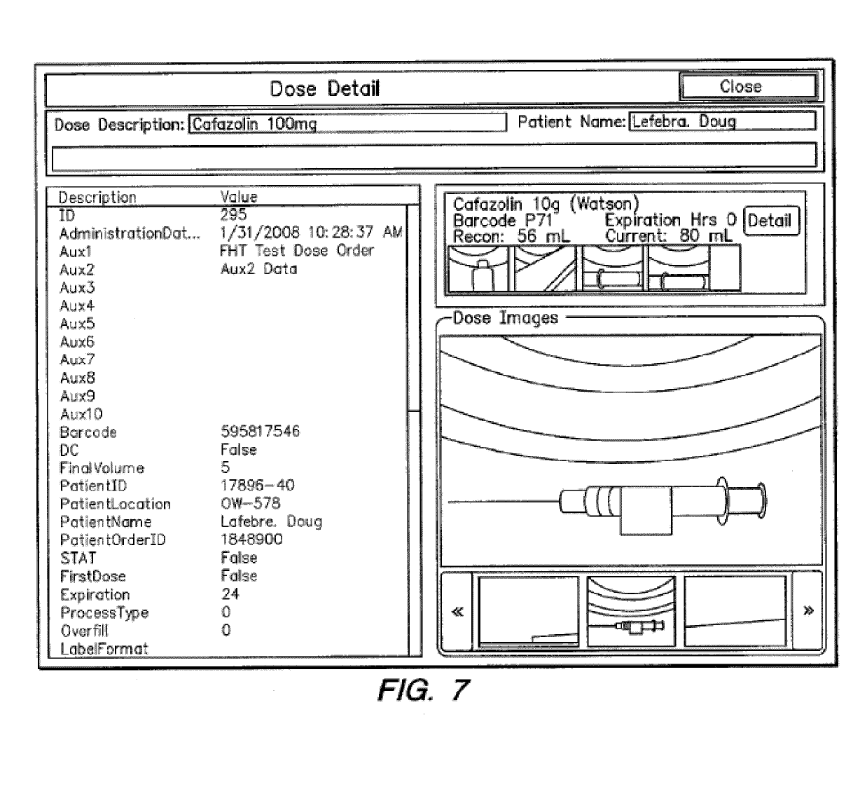

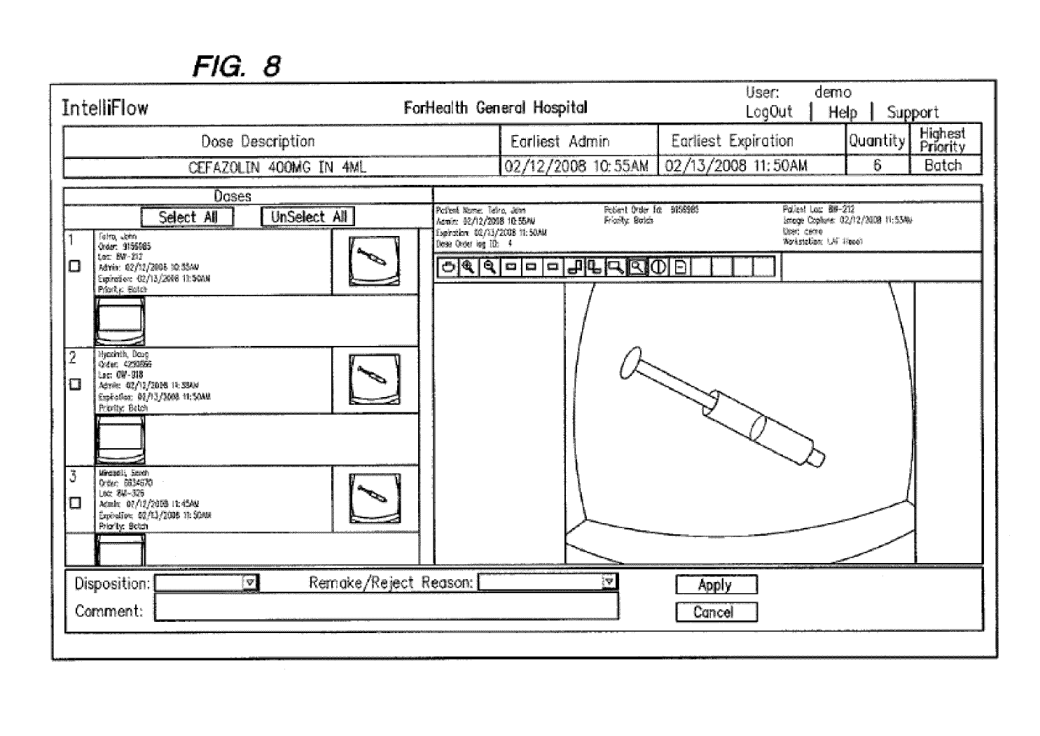

Another aspect of the present invention is that it provides a portal for remote inspection of prepared doses and thus facilitates the practice of telepharmacy, by which a pharmacist can inspect the dose preparation from any location inside the hospital or elsewhere so that doses are released more quickly and efficiently. Accordingly, dose inspection/verification can be performed by a pharmacist from any location using the portal of the present invention. Dose information such as can be collected and stored as the recipe or protocol for order fulfillment is performed, and any images that have been captured (see FIGS. 7 and 8) are presented to the pharmacist for inspection and approval. Images, such as those in FIGS. 7 and 8, can be presented through a conventional browser, optionally with the use of a plug-in or other active code that provides magnification, rotation, contrast, and other adjustments for closer inspection.

The pharmacist can thus look not only at images of the final product, including the product label, and other related product information, such as barcode information, but also, the pharmacist can review information and images that are obtained at particular steps in the overall drug preparation process. For example, during a drug reconstitution process, the operator is stepped through the drug preparation as described above and must confirm that each step was successfully completed. One of the steps is the selection of a particular drug vial and this event can be captured using a camera to produce an image that can later be reviewed by the pharmacist or a scanning event by which the operator identifies the drug vial being used. The pharmacist can view each or many of the steps that was taken in order to confirm that the step was properly completed and thus, the dose was properly prepared. Many times in a pharmacy, a clerk is working under the supervision of a pharmacist and it is the clerk that actually processes the dose order. Thus, in the event of any questions about an order, the pharmacist is limited to speaking with the clerk. This aspect of the present invention offers a superior and more complete way of inspecting and verifying the drug order in order to release it to the patient since the pharmacist can visually inspect the different, multiple images and/or data obtained during the various steps of preparing of the drug to confirm that the steps were carried out properly and thus, ultimately conclude whether the dose order was properly prepared and should be released to the patient. This can be important in many circumstances, including when the constituent components of the final dose include more than one clear fluid such that a visual inspection of the final dose cannot provide a basis for the pharmacist to confirm the accuracy of the dose. Thus, a benefit results from the capture and review steps described above, regardless of whether the pharmacist is on-site or remotely situated.

FIGS. 7 and 8 show the various images that can be selected by the pharmacist in order to view the final dose order, in this case a syringe filled with medication. Different angles and different views are available to the pharmacist, as well as information that has been captured in other ways such as by scanning or weighing steps, if called for in the recipe at the workstation that prepared the final dose being inspected.

Preferably, the local server 330 includes web services or a communication module that enables the data records associated with the dose order and its production to be viewed through a conventional web-browser program. As such, the pharmacist no longer has to be physically within the pharmacy to inspect and verify dose orders and ultimately either approve and release the dose order or reject the dose order. The opportunities that this system presents are varied and great. For example, a number of pharmacies can subscribe to a service where pharmacists inspect and verify dose orders from a remote location, either all the time or after the close of normal business hours. In addition, when the drug orders are prepared by automated drug preparation devices as opposed to pharmacy clerks, the inspection and verification process can be outsourced to one or more pharmacists who review and verify the dose orders.

In addition, a panel of pharmacists can, at one or more remote locations, review the dose orders that have been prepared by a number of different workstations (both automated and manual), regardless of the location of such workstations. Each pharmacist can review all of the digital records and stored information as described above as part of the inspection process and then can approve the dose order for release if the pharmacist concludes that the dose order was properly prepared. The approval process can comprise messages communicated through the portal, e.g., a web-browser application such that the pharmacist simply logs into the system and approves particular orders by mouse-clicks, keystrokes, and other conventional inputs that are forwarded to the local server that was the source of that particular dose order. A conventional login process with password and optionally further user-authentication ensures that the pharmacist's identity is verified before providing access to the pharmacist to any dose order information. The system can be designed so that for each dose order, the pharmacist must enter a unique identifier, such as a password, in order to release the drug. The date and time of the inspection and release or rejection of the dose order is also logged. Optionally, this information can be associated with the dose order record so that the approval stage is saved together with the processing steps to fill the dose order. In this manner, a record of which pharmacist has approved a particular dose order can be saved.

It will be appreciated that an entity can be formed in which pharmacist-members span the world in different time zones so as to have a pharmacist available regardless of the time of day to inspect and release or reject a particular dose order. The pharmacists can thus be part of an organization or a corporation that offers this service to different pharmacies across the globe. To accommodate different languages, the software can be configured to offer the dose order information in different languages, which can be selected in a pull down menu on a screen, such as a login screen.

With continued reference to FIG. 2, in step 230, if the pharmacist approves the dose order, then the dose order is released in step 240. The determination as to whether to approve the dose order is not managed by the present system. Rather, that determination is made by the pharmacist with the system providing detailed tracking of the recipe followed to prepare a particular dose order so that the pharmacist can make the approval decision using “over-the-shoulder” information, that is, information captured during the course of dose preparation as though he were looking over the shoulder of the operator of the workstation where the dose was prepared. On the other hand, if at step 230 the pharmacist does not approve the dose order based on the information presented to the pharmacist, then the dose order is rejected and the original order is added back the dose order queue at step 250 for preparation anew. At step 260, the local database and the situation board are updated to reflect whether the dose order was released or not. At a later time, the local database can communicate the completed dose information including any dose-approvals and dose-rejections from the local server 330 to the central server 390.

The above discussion is generally directed to the preparation and fulfillment of medication dose orders and the tracking of the dose order from origination to delivery. However, the present invention also applies to a method and system for the centralized preparation and delivery of medications in anticipation of use (i.e., at times before a patient-specific dose order has been prescribed or presented for fulfillment), such as described in the aforementioned U.S. application Ser. No. 11/844,135, by having workstation operators at manual workstations and automated workstations capture information at steps in the dose-order preparation process for approval as previously described.

With reference now to FIG. 3, topology 300 illustrates an environment in which a central server 390 communicates with local servers of each of potentially numerous pharmacies, hospitals, or other healthcare providers, each of which is generally identified at 310. These entities 310 can communicate with a respective local server 330 configured to implement the processes described herein (such as shown in FIGS. 1, 1A and 2) from a conventional pharmacy information system 320. The pharmacy information system 320 is the location where drug orders are initially entered for processing. The system 320 can thus include one or more stations where a doctor or other person can enter individual drug orders, such as orders for IV admixtures. The pharmacy information system 320 communicates with the local server 330 which preferably includes the functionality described above, including at least the label processing module that extracts drug order information from the pharmacy information system messages or data streams (and optionally a fulfillment module that determines whether new medication preparations are required or are already available in inventory), a database and a database query module that supports read and write operations to the database, and a communications module such as a web services module that supports communication with servers and other machines at remote locations. Optionally, the local server 330 comprises plural, dedicated servers. The pharmacy information system 320 and the local server 330 can be connected across various types of communication links or network segments. For example, communications can be transported over the Internet, a private network, or across a virtual private network (VPN). Further, the server 330 can communicate using a variety of communication interfaces such as IEEE 1284 (parallel port), USB or USB 2.0 port, IEEE 1394 (“Firewire”), IEEE 802.11 transceiver variants, Bluetooth transceiver, infrared port, or 10Base-T and 100Base-T Ethernet, or one of a variety of emerging interfaces. A variety of protocols can be employed for communication with the pharmacy information system 320 and with other workstation, databases, and servers and devices, including, for instance, TCP/IP and WAP. Communications between the entities 310 and the server 330 are preferably secure (e.g., utilize HTTPS, SSH, VPN, DES encryption or RSA encryption) so as to prevent the interception or snooping of potentially sensitive medical information such as patient history and medication orders.

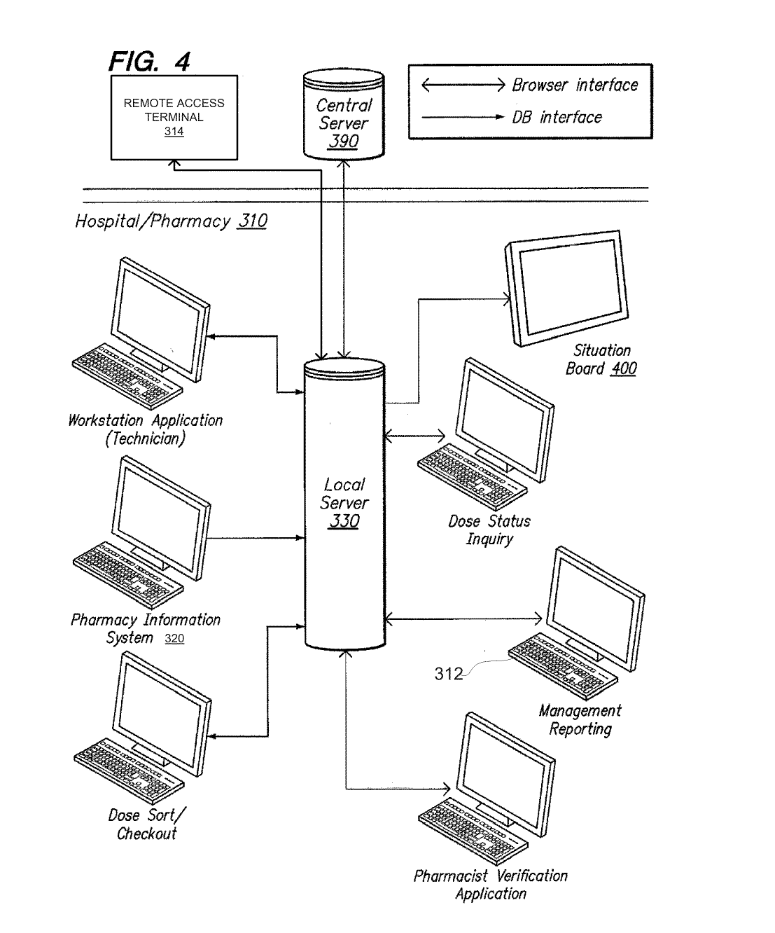

As illustrated in FIG. 4, the local server 330 within each hospital or pharmacy 310 is in communication with a number of devices and is in exclusive communication with the central server 390. The pharmacy information system provides label information to the database and that data is received at the local server 330 and processed by the label processing module as described above. Likewise, various workstations receive data from the local server and guide technicians in the preparation of medication doses while also providing captured images and other data to the database through communications with the local server. A pharmacist provides verification through a portal connection to the local server, such as a secure connection through the Internet, using a browser and/or an application that provides tools to aid in the review process (e.g., to magnify, rotate or otherwise manipulate the captured data associated with a given preparation). Finished doses are noted, sorted, and checked-out of the preparation queue or inventory as a function of the completion of process flows such as described above in connection with FIGS. 1, 1A and 2. All the while, the situation board 400 presents metrics relating to the in-progress, yet-to-be-started, and completed doses using data provided by the local server, and more preferably from a dose status module operating on the local server or a machine connected thereto. Similarly, devices such as terminals can communicate with the local server 330 to query the status of dose preparation or gather reports on productivity, errors, workstation throughput, or other operational parameters (including parameters of interest to an information technology professional).

Beyond each of the pharmacies and hospitals that have a respective local server 330, there is a central server 390 that communicates only with the local servers. Each local server preferably runs a number of other services that assist in the management of information and periodic communication with the central server 390. In an implementation of the present invention, an Ensemble server includes a number of services in the form of code (e.g., software modules) that support system operation. For instance, a data backup and purge service has a rule base that defines the time period for the local server to maintain data. The time period is set so as to balance machine efficiency with the desirability of having data stored locally. This service operates to send data to the central server 390 at intervals or in response to events. Thus, for instance, data can be provided to the central server every minute and the local copy of any captured image data can be purged after 45 days. A system status service monitors the performance of the local server 330 and provides an administrator with information relating to the success or failure of data backup operations, system slowdowns, and the like. A dose order monitor service generates the data shown on the situation board 400, and the rules and parameters used for generating this data can be established in a profile that the service refers to. In addition, the dose order monitor service can advise of any doses that are not being made by any of the workstations at that particular location 310. A notification service operates to send messages such as emails by SMTP or instant messages using an IM protocol.

In one embodiment, the pharmacy information system 320 sends a label print stream to the server 330. The entity 310, whether it is a hospital, pharmacy, healthcare provider or the like communicates with the server 330 which, in turn, coordinates and manages the medication ordering and fulfillment process. Optionally, communication can be handled at the server 330 by a communication module. In addition, if the healthcare providers 310 communicate with the server 330 via a world-wide-web interface, the communications module can comprise a web server, such as Microsoft Internet Information Service (IIS) or Apache Web Server. The communications module, regardless of its form, preferably manages certain administrative and communication tasks so as to offload the processing demands placed on the server 330. For example, the communication module can authorize healthcare providers 310 access to data maintained by the server 330 through secure key or password protection. Further, the communications module can encrypt outgoing traffic and decrypt incoming traffic.

In the illustrated embodiment, the server 330 includes a label processing module and optionally an attached printer that can generate labels for medications prepared in anticipation of use as well as any medication doses that have been matched with a patient-specific dose order. Labels can be printed in standard fonts or typeface as well as be printed with bar-codes or otherwise encoded in a machine readable format. Furthermore, label printing can include electronically writing data to an RFID tag or similar device, if desired.

The label processing module can comprise code executing in the server so as to capture the printed label feeds, parse the labels, and post the dose order information into a database communicatively coupled to the server 330. The label processing module can be of the type described in commonly assigned U.S. Pat. No. 7,096,212, which is hereby incorporated by reference in its entirety. The label processing module supports a variety of methods for receiving label stream input including TCP, LPD, and any file transfer protocol. Preferably, the module includes language interpreters for a number of commonly used label-printer languages including Zebra, DataMax, SATO and Intermac.

Preferably, the server is able to receive and post to the database drug orders that are already in a format for posting, in other words, that do not require processing by the label processing module. Properly formatted drug orders can be posted using suitable database commands, such as commands in MySql, when a sequel database is used. Preferably, however, all drug orders from pharmacy information systems 310 pass through a processing module, even if not in the form of a “label” for data verification.

The server 330 also includes a local database (cache) server that is hosted locally at each site, such as a hospital or pharmacy, etc. The local database can be in the form of an Ensemble database, commercially available from InterSystems. The database stores a rolling “cache” of the current in-process work, as well as the works from a predefined number of previous days, such as the past 30-45 days, thereby creating a dose order history that can be later accessed and reviewed even in if there is a temporary disruption of communication lines to a primary server at a different location. As described further below, the central server 390 preferably maintains an archive of data from each installation 310 and provides reporting functionality to thereby free the individual hospitals and pharmacies from maintaining all of the gathered data for an indefinite period of time. Data of various kinds including images (such as JPEG images), are captured during the dose preparation process and this data is stored in the local Ensemble database. Thus, the incoming print stream that is received, parsed and interpreted by the label processing module can be placed into the local Ensemble database and that record augmented as the dose order is being filled with data collected during each or selected ones of the steps in the recipe for producing the drug in the drug order.

Unlike conventional messaging products, the Ensemble database has a high performance, highly scalable and SQL-compliant object database at its core. This database leverages technology found in a Caché product offered by InterSystems, and scales easily to handle thousands of simultaneous users and terabytes of data. All elements of Ensemble itself are modeled as object classes in its database. This object model is extended, during solution development, by Ensemble's advanced abstraction facility to all of the applications, services, data sources, business rules, and other components of an integrated solution.

Data is synchronized to a hosted central server 390, described below, via a network 301 (e.g., via SOAP web service process over HTTPS) and is eventually purged from the local server. The label processing module can run on the same physical machine as the local database (e.g., Ensemble local database). The central server 390 can securely manage data received from numerous entities 310, including entities that are not associated with one another.

The server 330 also includes management software, such as the Ensemble production module, that manages the status of doses through the system, and is configured to monitor and compute metrics that are to be displayed on the Situation Board 400. In addition, the Ensemble production module sends email notifications and manages communications with external systems, including the backup/synchronization process to the central server 390. The Ensemble production module runs on the local database.

The database and web server utilized by the server 330 should be provided locally by facilities at the entity 310.

The Situation Board 400 shown in FIG. 5 is a browser-based “dashboard” application that displays the overall status summary information about the current operations within the pharmacy IV room or another site. The Situation Board is displayed in the pharmacy on a large size, widescreen, flat panel display for high visibility and can include the following metrics: (1) count and percentage of doses awaiting preparation, in-process, or awaiting verification; (2) current productivity compared to a 30 day average (or some other average); (3) state of each workstation in all pharmacy locations in the hospital or the like; (4) wait time for preparation and verification for selected doses, such as STAT and “First Dose” orders.

The Situation Board 400 of FIG. 5 includes a number of different sections that present useful information to personnel. For example, the upper left hand corner includes a dose order summary 510 in the form of a bar graph that includes the types of doses (e.g., STAT, FIRST, WAIT, HAZMAT) along one axis and a percentage value along another axis. A color code is provided so that the operator can easily determine the percentage of each type of dose (as well as the total doses) that are pending, in-process and waiting for verification. In this example, 100% of the WAIT and HAZMAT type doses are pending. In a top center section, a dose order productivity reading 512 is presented to the operator and maps out the total count over a period of time and allows the operator to compare the current productivity reading compared to an average productivity reading. The bottom area of the screen (bottom left, center and right) 520 shows the wait time of various types of various doses. For example, the average wait time for the completion of the dose preparation is listed, as well as the average wait time for dose verification. Available workstations and the number of dose orders being handled by each workstation are identified by icons in the upper right corner of the screen.

The Situation Board 400 can be hosted on a machine running a conventional web browser application, including the server 330. To achieve ease of deployment and support for a broad base of client platforms, the majority of the present system can be presented through a web-browser interface. The main advantage of a web-based interface is to allow remote access from any location without the need to install any client applications on the end user's PC. Cache provides two avenues for developing web-based applications, namely, Cache Server Pages and Zen and additionally, ASP.NET can also be used to access data that resides in the local database 330. The Situation Board 400 is one example of the web-based interface of the present system and is a highly-visible dashboard application for obtaining at-a-glance status information about pending and in-process dose orders.

As previously mentioned, the server 330 and in particular, the local database thereof, periodically sends the set of completed work (and other data changes) back to the central server 390 for backup. Data transfers to the central server 390 can be quite frequent such as in response to each write operation to the database of the local server 330 or infrequent such as on the order of minutes or hours apart. A backup of all “log” data (i.e., completed doses, captured data including images, and action logs), as well as “static” data, such as formulary and procedure information, are stored on the central server 390. After a period of time has elapsed, such as 30 to 45 days, some of the data (e.g., captured images) or all of the data can be purged from the database of the local server 330 if the transfer to the central server 390 has been verified. Data can be segregated in the same database by customer ID (and other security “keys” as needed) to prevent customers from accessing any data but their own. This enables a central server to securely host a number of installations each having their own server 330. Moreover, multi-site hospital networks can also access data across a subset of customer IDs for all hospitals in their network, while maintaining those sites as separate and distinct entities.

A principal chore for the central server 390 is to manage the backup process that runs from each local site in response to their respective data uploads. Once the central server 390 has verified to the local server that it has received the dose order and dose preparation data records intact, the local server is then free to purge information in accordance with the data retention polices at that facility. Meanwhile, the central server 390 can retain all of the information in archive, or can maintain only dose related information such as which dose, what hospital, how many generated each day, who approved, and the like. Customers can also access the site periodically for query and reporting purposes. An ancillary benefit of having the central server 390 manage a plurality of entities 310 is that it is uniquely positioned to track actual dose dispensing in terms of which medications are dispensed and when within multiple geographic territories, providing a wealth of patient-independent information that can be mined, if desired.

In accordance with another aspect of the invention, the central server 390 can leverage the data-transfer relationship and support the data archiving functionality through a method of charging entities 310 on the basis of the number of doses prepared. Because each of the hospitals and pharmacies communicates regularly with the central server, and because the central server is maintaining information on prior dose-preparations, a tabulation module can operate to associate each data upload session with a particular installation and tally the number of records uploaded to the central server. At a prescribed interval, such as monthly or quarterly, an invoice can be generated in an amount that is a function of the quantity of information uploaded. Thus, the invoice can reflect a charge for each record uploaded, or a tiered-charge structure in which there is a fee for each of one or more bands of uploads (e.g., for the first 1000 uploads, the next 4000 uploads, etc.), or for the size of the upload (e.g., a charge calibrated to Gigabits of storage associated with that installation), as a few examples.

In yet a further aspect of the invention, the central server 390 can have a dose metrics module that processes incoming data from each particular hospital or pharmacy, and provides reports to administrators regarding the data from such hospital or pharmacy, or with respect to a group of hospitals or pharmacies that are commonly owned or that are in competing geographic, academic, or specialty areas. The dose metrics can be programmed to identify, among other parameters, how many different drugs a hospital, pharmacy or set of installations are using, the average time to produce a given dose, the number of errors in producing a given dose, the number of re-dos for a given dose.

As well, the dose metrics module can be programmed to benchmark the performance of a given hospital or pharmacy against that of another hospital or pharmacy. In this regard, a hospital system with multiple pharmacies can identify the most efficient or accurate pharmacies in its group, and can identify medication-preparation protocols that optimize processing through a comparative report across installations. Optimizations can be had at the operation level, as just described, and also with regard to resource allocation, such as by distributing drug orders that is statistically more likely to have fewer errors or faster handling of a given drug order (assuming there is more than one suitable pharmacy to select). Similarly, there can be new optimization capabilities at the purchasing level by comparing the handling of different drugs that are suitable for treating the same illness. For instance, if drugs A and B both are suitable for treating a given ailment, the drug metrics module might identify that drug A, although more costly, is more accurately prepared with fewer errors and re-dos and therefore is the better choice for filling the prescription, when substitutions are permitted. More generally, benchmarking includes an application of a rule base (algorithm) to the data collected from the various entities 310 to output a report or recommendation concerning future drug preparation, and that recommendation can concern training of pharmacists and their staff, workstation selection and quantity, hours of operation, material stocking, and the like.

The connection between the local server and the central server is over a network such as the Internet. The frequency of this backup can be hourly, daily, or at some other interval selected in view of the bandwidth available at the local site or other constraints or preferences. To provide additional safety, a secondary central site 392 can be provided and serve as an offsite disaster recovery site where critical data can be stored. The data can be sent (backed up) from the primary central server 390 to the secondary central site 392 in a conventional manner.

The server 330 is in bi-directional communication with a number of workstations to allow the workstations 500, 510, 520, etc., to receive the drug order queue and details concerning the individual drug orders. In addition, confirmatory acts that are performed at the workstations (e.g., capturing images and scanning barcodes) are transmitted to the server 330 for storing in the local database. Any number of different workstations can be a part of the present system. For example, FIG. 3 shows a FlowHood Workstation A 500; a FlowHood Workstation B 510 and a Chemo Workstation 520. However, other workstations can be part of the system including manual drug preparation workstations, automated workstations, and workstations that are specifically used to prepare a certain type of drug order can be connected to the server 330 to receive drug orders and report drug order processing.

A client application is provided at each workstation. The workstation can include a touch screen, one or more bar code scanners, label printers and a camera. Additional hardware that can be present at the workstation can include a scale, a reconstitution module (mixing station) and/or a security ID badge reader. The client application is preferably a web-based application and therefore, the specific location of the workstation relative to the server 330 is not critical since communication between the two is over a network, and so data and business logic of the server 330 can be communicated in a conventional manner, such as via a web-service using SSL http protocol (https) over the standard web port (80) that is typically available for web access through network firewalls. This architecture allows the server to be hosted locally, at the customer site, or at an ISP on the internet, with no changes to the application itself.

The drug order queue that is assembled in the server 330 is preferably displayed on the situation board 400 as well as at each of the various workstations. The display at the workstations can comprise a touch screen device to permit inputs via direct contact with the display. The touch screen can be provided at each location where doses are prepared, e.g., inside the pharmacy IV cleanroom. A camera is used to capture JPEG images or other images of dose preparation activities for later inspection (images are stored directly in the database). A foot-pedal, barcode scanner, and audible cues are used to keep the application hands-free during the preparation process. Unlike conventional systems where a single pharmacy printer prints all of the drug order labels prior to actually preparing the drug orders, the printing of the drug order labels preferably takes place only at the specific workstation that is fulfilling the drug order. Since the dose labels are printed at their point of use, the need to sort large batches of labels is eliminated, and therefore, they are prevented from getting lost in the pharmacy or being matched with the incorrect dose are minimized if not eliminated. Dose preparation instructions are presented to the technician as described herein. Detailed instructions and reference materials, such as PDF documents or web sites, can be referenced at the workstation.

The workstation communicates with the local database at the server 330 via a web service (e.g., SOAP web service) using the built-in web services capabilities of the server 330. Various reports can be generated via a connection to the database.

It will also be appreciated that the touch screen workstation can include voice recognition software to allow the operator to use voice commands to navigate. For example, the operator can navigate through a menu and review the drug order queue and even make a selection from the drug order queue using voice commands. By using the foot-pedal and voice commands, the operator can also capture images of the product and other objects as well as scanning the product, etc.

The work flow process described herein includes a “kitting” function that organizes work into appropriate kits, prints picking documents to assist the technician in locating and securing the appropriate drugs and supplies. Bar codes or the like can be used to verify the selected drugs and the work flow process includes issuing a kit report that tracks the work into and through the IV room or other room.

Dose tracking takes a number of forms. The situation board provides one manner of dose tracking because it maintains a high level view of the work being performed in the pharmacy and because is configured to immediately instruct an observer regarding any incomplete work. Moreover, color coding on the situation board can immediately identify the amount of work that is pending preparation, under preparation or prepared but not yet checked out by a pharmacist (i.e., orders not yet approved for release. Dose tracking is also provided at each step in the dose preparation process, including without limitation, the selection and preparation of the ingredients, pharmacist checking, removal from the IV room for delivery to a patient, and the actual delivery of the dose to the floor. Each of these steps is part of the work flow process that is tracked in the system managed by the server 330. As well, there is a dose query function that permits any authorized user to probe the database to discover the current status of any particular dose or group of doses. Also, the situation board maintains alarms for doses that are due and also tracks doses whose preparation must be delayed because of limited stability in solution.

Because the information is being stored in a database over long periods of time, the system develops metrics that demonstrate workload vs. staffing patterns; when the workload deviates from a “normal” condition, and when the workload is out of control; thereby permitting managers to adjust staffing for work load needs. Furthermore, the central server 390 can develop metrics that cover greater regions than gathered at any given server 330.

In yet another aspect of the present invention, the NDC number can be used when the system is configured to “push” the dose orders to the individual workstations. Incoming drug orders can be identified by their NDC numbers and the local server selects which workstation is best capable of handling the incoming dose order based, at least in part, by their NDC numbers and then assigns the dose order to the workstation. The dose order is then sent to the workstation for fulfillment of the order. For example, chemo drugs can be identified as such by their NDC number and the local server will select a workstation that is intended to handle chemodrugs. To implement this earmarked type routing, a database at the local server can include the NDC numbers to assist in routing certain medications to specific station or otherwise assist in ordering the drug orders on the situation board.

The present system therefore provides a composite workflow application that can layer on top of a hospital's existing pharmacy information system 320, without requiring any changes to that system, in order to manage the production of IV doses (and other doses) in the pharmacy, track dose delivery from the pharmacy, prevent medication errors caused by incorrect dose preparation, capture detailed history of dose preparation (including images), and serve as a gateway to automation systems throughout the pharmacy, such as carousels, compounders, and IV robots.

It will be appreciated that the present system eliminates the stacks of paper labels used by the current entirely manual process and the system provides greater visibility into the entire process, uses bar code verification to prevent the possibility of adverse drug events causes by dispensing errors, and improves the overall quality of life for the IV room or other department.

The present system combines a macro-level workflow manager that tracks the status of dose production in the pharmacy IV room from the receipt of the dose order, through preparation at a workstation that can include a laminar flow hood or chemotherapy bio-hazard cabinet, or distribution to an automated system for preparation, dose verification by a pharmacist, and finally to sorting and distribution from the pharmacy. Additionally, a micro-level workflow manager is provided at the dose preparation station. Using a combination of a touch screen, base code imager, camera, printer, foot pedal input and other equipment, the system ensures proper and complete preparation of each dose and provides full traceability to the products used during preparation.

In order to overcome the liabilities associated with a pure ASP mode, the workflow management system of the present invention is architected with a two-stage data process in which immediate operations are managed using a local server (also called a data cache) and such operations are continuously backed up to a network (Internet). The system therefore looks like an ASP to a user performing long term data retrieval and analysis, but on the other hand looks like a local application to the persons performing the mission-critical work. This ensures availability of critical data at all times for the entity 310 using the system.

The architecture is further divided into workstation applications that are deployed as thick clients to workstations located at each drug preparation area. The workstation applications are localized to the IV room and drive printers and other equipment, and so are more suitably deployed as thick clients. All other functions can be performed at any workstation at which the pharmacist finds him or herself, and so are mediated as thin clients using ubiquitous Internet browsers, which eliminates the need to physically deploy the software to those locations. This permits scalability and ready-access by a pharmacist that may be performing a drug dose inspection from a remote location.

In yet another aspect, the architecture and arrangement of the systems of the present invention provides the ability of multiple sites (local or remote) to place orders to a central filling site in a manner as described above. The central filling site processes each dose in accordance with the received instructions to generate a medication dose for delivery to a patient. As the medication dose is prepared, associated dose preparation data is generated at the central filling station and can be stored. The central filling site can then transfer the associated dose preparation data back to the ordering site using electronic means when the physical medication dose is sent back and received at the ordering site. Thus, the receipt of the medication dose along with the associated dose preparation data at the ordering site permits confirmation of the process, approval and release of the medication dose. For example, comparison between the dose preparation data and the medication dose (e.g., identifying information thereon (e.g., bar code, etc.) ensures the integrity of the dose preparation process. In addition, by having the dose preparation data, which can outline all the steps that were taken to prepare the dose, a person can more easily confirm and approve the dose preparation, thereby allowing the dose to be released to the patient. For example, as described above, each dose preparation can have a documented protocol (steps) that the person or machine follows to prepare the dose.

The present system provides a number of advantages including: (1) elimination of non-productive workload associated with label tracking and management; (2) elimination of non-productive time spent by pharmacists entering and leaving clean facilities used to prepare IVs for checking purposes; (3) provision of complete record-keeping on an activity that is now fundamentally impossible to document; (4) transfer of workload from scarce pharmacists to relatively abundant technicians; (5) entry of orders for IV admixtures into a hospital pharmacy information system that produces labels in a just-in-time manner for those doses that are actually being prepared and hence that are currently required for placement on the final drug dose; (6) transfer of label data to a server where they are electronically read and placed into a database; (7) configuration of computer workstations at each preparation location with knowledge of what doses on the list of pending doses their respective operators can prepare; (8) selection of doses by the user (typically, a pharmacy technician or operator) to be prepared, with labels printing only after that selection at a printer located at that workstation, with concomitant settings of that dose order as being “unavailable” to other workstations (this grouping of doses, all of which have the same medication(s) at the same dose(s), is called a “micro-batch”).

While the invention has been described in connection with a certain embodiment thereof, the invention is not limited to the described embodiments but rather is more broadly defined by the recitations in the claims below and equivalents thereof.

1.-55. (canceled)

56. A method for management of dose order records corresponding to medication dose orders with suspected duplicate medication dose orders, comprising:
storing a plurality of dose order records at a database, wherein each dose order record is stored in corresponding relation to one or more dose order record data fields populated with dose order metadata regarding each dose order record;
identifying a first dose order record;
comparing dose order metadata regarding the first dose order record with corresponding portions of dose order metadata from the plurality of dose order records in the local database;
determining a predetermined correspondence between the dose order metadata regarding the first dose order record and the dose order metadata regarding at least one other dose order record of the plurality of dose order records;
associating the first dose order record with the at least one other dose order record in response to the determining; and
presenting to a user an indication that the first dose order record is potentially a duplicate of the at least one other dose order record.

57. The method of claim 56, wherein the first dose order record corresponds to a new dose order record received at the database.

58. The method of claim 56, wherein the predetermined correspondence is configurable by an administrator of the database.

59. The method of claim 56, wherein the presenting comprises:
displaying the first dose order record in associated relation to the at least one other dose order record; and
soliciting a user to verify the first dose order record is a duplicate of the at least one other dose order record.

60. The method of claim 59, wherein the soliciting comprises:
providing the user at least a first selection that confirms the first dose order record is a duplicate of the at least one other dose order record and a second selection that denies the first dose order record is a duplicate of the at least one other dose order record.

61. The method of claim 60, wherein, upon selection by the user of the first selection, the first dose order record is removed from a dose order record listing so that the first dose order record is not visible at a preparation station in operative communication with the database.

62. The method of claim 60, wherein, upon selection by the user of the second selection, the first dose order records is disassociated from the at least one other dose order record, wherein the first dose order record is added to a dose order record listing so that the first dose order records is visible at a preparation station in operative communication with the database.

63. The method of claim 56, wherein the presenting is in response to a scan event corresponding at least one of to the first dose order record or the at least one other dose order record.

64. A system for management of dose order records corresponding to medication dose orders with suspected duplicate medication dose orders, comprising:
a database that stores a plurality of dose order records that are each stored in corresponding relation to one or more dose order record data fields that are populated with dose order metadata regarding each respective dose order record;
a dose logic engine in operative communication with the database, wherein the dose logic engine comprises logic to:
compare dose order metadata regarding a first dose order record with corresponding portions of dose order metadata from a plurality of other dose order records in the database,
determine a predetermined correspondence between the dose order metadata regarding the first dose order record and the dose order metadata regarding at least one other dose order record of the plurality of dose order records, and
associate the first dose order record with at least one other dose order record in response to the determining; and
a user interface in operative communication with the dose logic engine to present to a user an indication that the first dose order record is potentially a duplicate of the at least one other dose order record.

65. The system of claim 64, wherein the first dose order record corresponds to a newly received dose order record received at the database.

66. The system of claim 64, wherein the predetermined correspondence is configurable by an administrator of the database.

67. The system of claim 64, wherein the user interface is operative to display the first dose order record in associated relation to the at least one other dose order record and is operative to receive a verification from a user to verify the first dose order record is a duplicate of the at least one other dose order record.

68. The system of claim 67, wherein the user interface is operative to provide the user at least a first selection that confirms the first dose order record is a duplicate of the at least one other dose order record and a second selection that denies the first dose order record is a duplicate of the at least one other dose order record.

69. The system of claim 68, wherein, upon selection by the user of the first selection, the first dose order record is removed from a dose order record listing so that the first dose order record is not visible at a preparation station in operative communication with the database.

70. The system of claim 68, wherein, upon selection by the user of the second selection, the first dose order records is disassociated from the at least one other dose order record, wherein the first dose order record is added to a dose order record listing so that the first dose order records is visible at a preparation station in operative communication with the database.

71. The system of claim 64, further comprising:
a reader operative to scan a tag associated with at least one of to the first dose order record or the at least one other dose order record, and wherein the user interface is operative to present the indication in response to a scan event at the reader.

72. A method for management of dose order records corresponding to discontinued medication dose order records, comprising:
storing a plurality of dose order records in a database, wherein each dose order record is stored in corresponding relation to one or more dose order record data fields populated with corresponding dose order metadata regarding each dose order record;
receiving a discontinued dose order at the database;
comparing dose order metadata regarding the discontinued dose order record with corresponding portions of dose order metadata from the plurality of dose order records in the local database;
determining a predetermined correspondence between the discontinued dose order record and at least one other dose order record of the plurality of dose order records;
associating the discontinued dose order with the at least one other dose order record in response to the determining; and
changing a status of the at least one other dose order record from a current status to a discontinued status in response to the determining.

73. The method of claim 72, wherein the at least one other dose order record has not been prepared, and wherein the method further comprises:
removing the at least one other dose order record from a dose order record listing maintained at the database.

74. The method of claim 72, wherein the at least one other dose order record has been prepared, and wherein the method further comprises:
removing the at least one other dose order record from a dose order record listing maintained at the database; and
storing the prepared dose as a product corresponding to a work in progress entry in the database.

75. A system for management of dose order records corresponding to discontinued medication dose order records, comprising:
a database that stores a plurality of dose order records that are each stored in corresponding relation to one or more dose order record data fields that are populated with dose order metadata regarding each respective dose order record;
a dose logic engine in operative communication with the database, wherein the dose logic engine comprises logic to:
compare dose order metadata regarding a discontinued dose order record with corresponding portions of dose order metadata from the plurality of dose order records in the database;
determine a predetermined correspondence between the discontinued dose order record and at least one other dose order record of the plurality of dose order records;
associate the discontinued dose order with the at least one other dose order record in response to the determining; and
change a status of the at least one other dose order record from a current status to a discontinued status in response to the determining.

76. The system of claim 75, further comprising:
a user interface in operative communication with the dose logic engine to present to a user an indication that the at least one other dose order record has been changed from a current status to a discontinued status.

77. The system of claim 75, wherein the at least one other dose order record has not been prepared, and wherein the dose logic engine is operative to remove the at least one other dose order record from a dose order record listing maintained at the database.

78. The system of claim 75, wherein the at least one other dose order record has been prepared, and wherein the dose logic engine is operative to remove the at least one other dose order record from a dose order record listing maintained at the database and modify a status of the prepared dose to a product corresponding to a work in progress entry in the database.

79.-84. (canceled)
